(19) United States
(12) Patent Application Publication
(10) Pub. No.: US 2026/0277083 A1
(43) Pub. Date: Sep. 17, 2026

(54) LENS ADAPTER DEVICE, MOBILE PHONE PROTECTIVE CASE, AND HIGH-DEFINITION MOBILE PHONE PHOTOGRAPHY SYSTEM

(71) Applicant: SHENZHEN LEQI INNOVATION CO., LTD., SHENZHEN (CN)

(72) Inventor: ZHIQIANG PAN, SHENZHEN (CN)

(21) Appl. No.: 19/671,251

(22) Filed: May 8, 2026

(30) Foreign Application Priority Data
Mar. 10, 2025 (CN) 202510278190.1
Jul. 14, 2025 (CN) 202510967948.2

(51) Int. Cl. G03B 17/56; G02B 9/60; G02B 13/00; G03B 17/12

(52) U.S. Cl. CPC G03B 17/565; G02B 9/60; G02B 13/005; G03B 17/12

(57) ABSTRACT

A lens adapter device for a mobile phone high-definition photography system is provided. The mobile phone high-definition photography system includes a mobile phone protective case for mounting a mobile phone. The lens adapter device includes a lens barrel, a first lens unit disposed within the lens barrel, and a second lens unit disposed within the lens barrel and spaced apart from the first lens unit. The lens barrel has a first end and a second end opposite each other. The first end is configured to detachably connect to a camera lens, and the second end is configured to detachably connect to the mobile phone protective case. An object-side surface of the first lens unit is planar, and an image-side surface of the first lens unit is convex. An object-side surface of the second lens unit is planar, and an image-side surface of the second lens unit is concave.

### TECHNICAL FIELD

The present disclosure relates to the technical field of photographic equipment, and in particular to a lens adapter device, a mobile phone protective case, and a high-definition mobile phone photography system.

### BACKGROUND

With the increasing prevalence of smartphones, photography has become an indispensable part of daily life. Whether taking still photos or recording videos, the smartphone camera has evolved into a crucial tool for users to capture and share their lives. However, despite considerable advancements in both hardware and software, particularly in image processing technologies, modern smartphone still exhibits certain limitations when it comes to long-distance shooting, high-magnification zoom, and imaging performance in complex scenes. For users who demand high-quality photography, especially in professional applications such as telephoto or macro shooting, the built-in smartphone camera commonly fails to achieve image quality comparable to those of professional cameras.

To address these issues, in the related art, accessories such as magnification lenses are typically attached to the rear of the smartphone camera to enhance its shooting capabilities.

However, achieving high-definition long-distance shooting with a smartphone generally requires specially designed phone lenses. The shooting range and image quality attainable with such lenses remain limited. Moreover, these lenses are not directly compatible with professional camera lenses, and thus cannot fully leverage the advantages of professional optics, resulting in an inability to utilize the high performance and superior imaging capabilities of professional camera lenses.

### SUMMARY

The present disclosure provides a lens adapter device, aiming to solve the problem in the related art that a mobile phone camera cannot be compatible with a camera lens.

To realize the above objective, the present disclosure provides a lens adapter device for a mobile phone high-definition photography system, the mobile phone high-definition photography system including a mobile phone protective case for mounting a mobile phone. The lens adapter device includes: a lens barrel having a first end and a second end opposite each other, the first end being configured to detachably connect to a camera lens, and the second end being configured to detachably connect to the mobile phone protective case; a first lens unit disposed within the lens barrel, an object-side surface of the first lens unit being planar, and an image-side surface of the first lens unit being convex; and a second lens unit disposed within the lens barrel and spaced apart from the first lens unit, an object-side surface of the second lens unit being planar, and an image-side surface of the second lens unit being concave.

In some embodiments, the first lens unit and the second lens unit are arranged along an optical axis of the lens adapter device and spaced apart from each other. The first lens unit includes: a first lens group having a positive optical power, an object-side surface of the first lens group being planar, and an image-side surface of the first lens group being convex; and a second lens group disposed on a side of first lens group facing the image-side surface of first lens group and spaced apart from the first lens group, the second lens group having a negative optical power, an object-side surface of the second lens group being concave, and an image-side surface of the second lens group being convex. The second lens unit includes: a third lens group having a positive optical power, an object-side surface of the third lens group being planar, and an image-side surface of the third lens group being convex; a fourth lens group having a positive optical power, an object-side surface of the fourth lens group being convex, and an image-side surface of the fourth lens group being planar; and a fifth lens group having a negative optical power, an object-side surface of the fifth lens group being convex, and an image-side surface of the fifth lens group being concave.

In some embodiments, the first lens unit includes two lens groups, and the second lens unit includes three lens groups. A total number of lenses in the first lens unit and the second lens unit is five; or, a total number of lenses in the first lens unit and the second lens unit is eleven.

In some embodiments, the first lens group includes a first lens, a second lens, a third lens, and a fourth lens arranged sequentially from an object side to an image side of the lens adapter device. An object-side surface of the first lens is planar, and an image-side surface of the first lens is convex and configured with a first radius of curvature. An object-side surface of the second lens is concave and configured with a second radius of curvature, and an image-side surface of the second lens is convex and configured with a third radius of curvature. An object-side surface of the third lens is concave and configured with a fourth radius of curvature, and an image-side surface of the third lens is planar. An object-side surface of the fourth lens is concave and configured with a fifth radius of curvature, and an image-side surface of the fourth lens is convex and configured with a sixth radius of curvature. The first radius of curvature is smaller than the second radius of curvature, the second radius of curvature is smaller than the third radius of curvature, the third radius of curvature is smaller than the fourth radius of curvature, the fourth radius of curvature is smaller than the fifth radius of curvature, and the fifth radius of curvature is smaller than the sixth radius of curvature. The first lens, the second lens, the third lens, and the fourth lens are arranged in contact with one another; and an effective optical diameter of the first lens is smaller than an effective optical diameter of the second lens, the effective optical diameter of the second lens is smaller than an effective optical diameter of the third lens, and the effective optical diameter of the third lens is smaller than an effective optical diameter of the fourth lens.

In some embodiments, the second lens group includes a fifth lens spaced apart from the fourth lens. An object-side surface of the fifth lens is concave and configured with a seventh radius of curvature, and an image-side surface of the fifth lens is convex and configured with an eighth radius of curvature, wherein the seventh radius of curvature is smaller than the eighth radius of curvature; and an effective optical diameter of the fifth lens is greater than the effective optical diameter of the fourth lens.

In some embodiments, the third lens group includes a sixth lens, a seventh lens, and an eighth lens arranged sequentially from the object side to the image side. An object-side surface of the sixth lens is planar, and an image-side surface of the sixth lens is concave and configured with a ninth radius of curvature. An object-side surface of the seventh lens is planar, an image-side surface of the seventh lens is concave and configured with a tenth radius of curvature, and an effective optical diameter of the seventh lens is equal to an effective optical diameter of the sixth lens; an object-side surface of the eighth lens is convex and configured with an eleventh radius of curvature, an image-side surface of the eighth lens is convex configured with a twelfth radius of curvature, and an effective optical diameter of the eighth lens is equal to the effective optical diameter of the seventh lens. The object-side surface of the sixth lens is spaced apart from the image-side surface of the fifth lens. The sixth lens, the seventh lens, and the eighth lens are arranged in contact.

In some embodiments, the fourth lens group includes a ninth lens. An object-side surface of the ninth lens is convex and configured with a thirteen radius of curvature, and an image-side surface of the ninth lens is planar. The object-side surface of the ninth lens is in contact with the image-side surface of the eighth lens. An effective optical diameter of the ninth lens is smaller than the effective optical diameter of the eighth lens.

In some embodiments, the fifth lens group is a cemented lens. An object-side surface of the cemented lens is convex, and an image-side surface of the cemented lens is concave. The cemented lens is configured to focus a light beam onto a same plane. An effective optical diameter of the fifth lens group is smaller than the effective optical diameter of the fourth lens group.

The present disclosure further provides a lens adapter device, including a lens barrel and a lens group disposed within the lens barrel, the lens group including a first lens group, a second lens group, a third lens group, a fourth lens group, and a fifth lens group sequentially arranged along an optical axis from an object side to an image side of the lens barrel. The first lens group has a negative optical power, and an image-side surface of the first lens group is concave. The second lens group has a negative optical power, an object-side surface and an image-side surface of the second lens group are both concave. The third lens group has a positive optical power, an object-side surface of the third lens group is concave, and an image-side surface of the third lens group is convex. The fourth lens group has a negative optical power, an object-side surface of the fourth lens group is concave, and an image-side surface of the fourth lens group is spherical. The fifth lens group has a negative optical power, an object-side surface of the fifth lens group is convex, and an image-side surface of the fifth lens group is concave. A focal length of the lens adapter device is recorded as f, an effective focal length of the second lens group is recorded as f2, an effective focal length of the third lens group is recorded as f3, and an effective focal length of the fourth lens group is recorded as f4. The following relationships are satisfied: 0.1<|f/f2|<0.3; 0.4<|f/f3|<0.6; and 0.03<|f/f4|<0.06.

In some embodiments, the second lens group includes a first lens and a second lens arranged along the optical axis from the object side to the image side. The first lens has a negative optical power, and the second lens has a negative optical power. A paraxial radius of curvature of an object-side surface of the first lens is recorded as R1, a paraxial radius of curvature of an image-side surface of the first lens is recorded as R1a, a paraxial radius of curvature of an object-side surface of the second lens is recorded as R2, and a paraxial radius of curvature of an image-side surface of the second lens is recorded as R2a. The following relationships are satisfied: 1<|R1/R1a|<1.4; and 0.2<|R2/R2a|<0.4.

In some embodiments, the third lens group includes a third lens and a fourth lens arranged along the optical axis from the object side to the image side. The third lens has a positive optical power, an object-side surface of the third lens is concave, and an image-side surface of the third lens is convex. The fourth lens has a positive optical power, an object-side surface of the fourth lens is planar, and an image-side surface of the fourth lens is convex. A paraxial radius of curvature of the object-side surface of the third lens is recorded as R3, a paraxial radius of curvature of the image-side surface of the third lens is recorded as R3a, and a paraxial radius of curvature of the image-side surface of the fourth lens is recorded as R4a. The following relationships are satisfied: 2.0<|R3/R3a|<2.6; and 45<|R4a|<65.

In some embodiments, length of the lens adapter device along the optical axis is recorded as L, an axial distance from the image-side surface of the second lens to the object-side surface of the third lens is recorded as T1, and an axial distance from the image-side surface of the third lens to the object-side surface of the fourth lens is recorded as T2. The following relationships are satisfied: 0.04<T1/L<0.08; and 30<T1/T2<40.

In some embodiments, the fourth lens group includes a fifth lens, a sixth lens, and a seventh lens sequentially arranged along the optical axis from the object side to the image side. The fifth lens has a positive optical power, an object-side surface and an image-side surface of the fifth lens are both concave. The sixth lens has a negative optical power, and an image-side surface of the sixth lens is concave. The seventh lens has a positive optical power, an object-side surface and an image-side surface of the seventh lens are both convex. A paraxial radius of curvature of the object-side surface of the fifth lens is recorded as R5, a paraxial radius of curvature of the image-side surface of the fifth lens is recorded as R5a, a paraxial radius of curvature of the image-side surface of the sixth lens is recorded as R6a, a paraxial radius of curvature of the object-side surface of the seventh lens is recorded as R7, and a paraxial radius of curvature of the image-side surface of the seventh lens is recorded as R7a. The following relationships are satisfied: 0.25<|R5/R5a|<0.40; 1.7<|R7/R7a|<2.1; and |R6a−R7|<5.

In some embodiments, a length of the lens adapter device along the optical axis is recorded as L, a paraxial distance from the image-side surface of the fourth lens to the object-side surface of the fifth lens is recorded as T3, and a paraxial distance from the image-side surface of the fifth lens to the object-side surface of the sixth lens is recorded as T4. The following relationships are satisfied: 5.5<T3/T4<6.5; 0.05<T3/L<0.08; 0.008<T4/L<0.015; and 0.55<T3/f<0.75.

The present disclosure further provides a lens adapter device, including a first lens group, a second lens group, a third lens group, a fourth lens group, and a fifth lens group sequentially arranged along an optical axis of the lens adapter device from an object side to an image side of the lens adapter device. The first lens group includes a first lens and a second lens; wherein each of the first lens and the second lens has a negative optical power; an image-side surface of the first lens is convex in a paraxial region; an object-side surface and an image-side surface of the second lens are both concave in the paraxial region. The second lens group includes a third lens and a fourth lens; wherein each of the third lens and the fourth lens has a negative optical power; an object-side surface and an image-side surface of the third lens are both concave in the paraxial region; an image-side surface of the fourth lens is convex in the paraxial region. The third lens group includes a fifth lens and a sixth lens; wherein each of the fifth lens and the sixth lens has a negative optical power; an object-side surface and an image-side surface of the fifth lens are both concave in the paraxial region; an object-side surface and an image-side surface of the sixth lens are both spherical in the paraxial region. The fourth lens group includes a seventh lens, an eighth lens, a ninth lens, and a tenth lens; wherein each of the seventh lens, the eighth lens, the ninth lens, and the tenth lens has a positive optical power; an object-side surface of the seventh lens is convex in the paraxial region; an object-side surface and an image-side surface of the eighth lens are both concave in the paraxial region; an object-side surface and an image-side surface of the ninth lens are both concave in the paraxial region; an object-side surface and an image-side surface of the tenth lens are both convex in the paraxial region. The fifth lens group includes an eleventh lens and a twelfth lens; wherein each of the eleventh lens and the twelfth lens has a positive optical power; an object-side surface of the eleventh lens is convex in the paraxial region; an object-side surface of the twelfth lens is spherical in the paraxial region, and an image-side surface of the twelfth lens is concave in the paraxial region. An effective focal length of the lens adapter device is recorded as f10, an effective focal length of the first lens group is recorded as f11, an effective focal length of the second lens group is recorded as f12, an effective focal length of the third lens group is recorded as f13, and an effective focal length of the fourth lens group is recorded as f14. The following relationships are satisfied: 140<f11/f10<150; 7.5<f12/f10<8.5; 4.2<f13/f10<4.8; and 270<f14/f10<290.

In some embodiments, a paraxial radius of curvature of the object-side surface of the third lens is recorded as R8, a paraxial radius of curvature of the image-side surface of the third lens is recorded as R8a, and a paraxial radius of curvature of the image-side surface of the fourth lens is recorded as R13. The following relationships are satisfied: 0.8<|R8/R8a|<1.0; 1.8<R8a/R13|<2.3; |R8+R8a|<15; and 45<|R8|<85.

In some embodiments, the fifth lens has a negative optical power, and the sixth lens has a positive optical power. A paraxial radius of curvature of the object-side surface of the fifth lens is recorded as R9, and a paraxial radius of curvature of the image-side surface of the fifth lens is recorded as R9a, a paraxial radius of curvature of the object-side surface of the sixth lens is recorded as R10, and a paraxial radius of curvature of the image-side surface of the sixth lens is recorded as R10a. The following relationships are satisfied: 6.0<|R9/R9a|<7.0; 0.7<R10/R10a|<0.9; |R9a−R10|<1.0; and 25<|R9|+|R10a|<35.

In some embodiments, a length of the lens adapter device along the optical axis is recorded as L, a focal length of the lens adapter device is recorded as f, and a distance from the image-side surface of the sixth lens to the object-side surface of the seventh lens is recorded as T5. The following relationships are satisfied: 0.025<T5/L<0.035; 0.25<T5/f<0.35; 1.8<T1/T5<2.2; and 3.0<T5<4.5.

In some embodiments, a paraxial radius of curvature of the object-side surface of the seventh lens is recorded as R11, a paraxial radius of curvature of the image-side surface of the seventh lens is recorded as R11a, a paraxial radius of curvature of the object-side surface of the eighth lens is recorded as R12, and a paraxial radius of curvature of the image-side surface of the eighth lens is recorded as R12a. The following relationships are satisfied: 0.15<|R11/R11a|<0.20; and 0.75<|R12/R12a|<0.95.

The present disclose further provides a mobile phone protective case, including the lens adapter device as described in any of the foregoing embodiments, a first mounting portion configured to receive a mobile phone, and a second mounting portion connected to the second end of the lens barrel by a threaded connection or a snap-fit connection.

The present disclose further provides a mobile phone high-definition photography system, including a mobile phone, a camera lens, and the mobile phone protective case as described in any of the foregoing embodiments.

According to the present disclosure, the combined arrangement of the first lens unit and the second lens unit in the lens adapter device solves the problem in the related art of incompatibility between a mobile phone lens and a professional camera lens. The first lens unit, configured with a planar object-side surface and a convex image-side surface, is configured for preliminary focusing and controlling the incident angle of the light beam, thereby ensuring the accuracy of light introduction during photography. The concave image-side surface of the second lens unit further receives and processes the light beam emitted from the first lens unit to control higher-order aberrations, thus improving image quality. In this way, not only is the imaging quality in complex scenarios such as telephoto and macro photography ensured, but the advantages of camera lenses can also be fully leveraged, enhancing the professional performance of the mobile phone photography system. Consequently, the mobile phone is rendered compatible with professional camera lenses, achieving the objective of high-quality photography on a mobile device.

### BRIEF DESCRIPTION OF THE DRAWINGS

FIG. 1 is a structural diagram of a lens adapter device according to an embodiment of the present disclosure.

FIG. 2 is a front view of a lens adapter device according to an embodiment of the present disclosure.

FIG. 3 is a cross-sectional view of the lens adapter device taken along line A-A in FIG. 2.

FIG. 4 is a cross-sectional view of the lens adapter device in FIG. 3 from another perspective.

FIG. 5 is an exploded view of a lens adapter device according to an embodiment of the present disclosure.

FIG. 6 is a structural diagram of a mobile phone high-definition photography system according to an embodiment of the present disclosure.

FIG. 7 is an optical diagram of a lens adapter device according to an embodiment of the present disclosure.

FIG. 8 is an optical diagram of a lens adapter device according to another embodiment of the present disclosure.

FIG. 9 is a field curvature diagram of a lens adapter device according to an embodiment of the present disclosure.

FIG. 10 is a schematic diagram of a lens adapter device according to yet another embodiment of the present disclosure.

FIG. 11 is a schematic diagram of a lens adapter device according to yet another embodiment of the present disclosure.

FIG. 12 is a field curvature diagram of a lens adapter device according to another embodiment of the present disclosure.

The realization of the objectives, functional features, and advantages of the present disclosure will be further described in conjunction with the embodiments and with reference to the accompanying drawings.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

It should also be noted that when an element is referred to as being “mounted on” or “disposed on” another element, it may be directly on the other element, or intervening elements may also be present. When an element is referred to as being “connected to” another element, it may be directly connected to the other element, or intervening elements may also be present.

Moreover, the terms “first”, “second”, and the like in the present disclosure are merely used for description and cannot be understood as indicating or implying their relative importance or as implicitly indicating the quantity of the technical features indicated. Thus, the feature defined by “first” or “second” may explicitly or implicitly include at least one such feature. In addition, the technical solutions of various embodiments may be combined with each other, but must be based on that the combined technical solutions can be implemented by those skilled in the art. When the combination of the technical solutions is contradictory or impossible to realize, it shall be considered that such combination does not exist and is not within the scope of protection of the present disclosure.

In the related art, accessories such as teleconverters are commonly attached behind a mobile phone camera to enhance photographic capabilities. However, achieving high-definition long-distance imaging with a mobile phone typically requires specially designed mobile phone lenses. These lenses still have limited shooting distance and imaging performance, and they cannot be directly compatible with professional camera lenses, resulting in failure to fully exploit the advantages of professional camera lenses, such as the high performance and imaging capabilitiesd. Currently, available lens adapters for mobile phones provide only a mechanical connection, lacking the necessary optical correction elements. This causes severe image distortion, blur, and chromatic aberration when a professional lens is attached to a mobile phone, preventing satisfactory shooting results. To address these issues, the present disclosure provides a lens adapter device that effectively connects a camera lens to a mobile phone, thereby enhancing the professional performance of mobile phone photography.

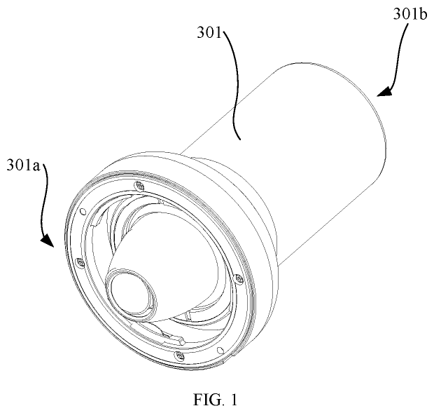

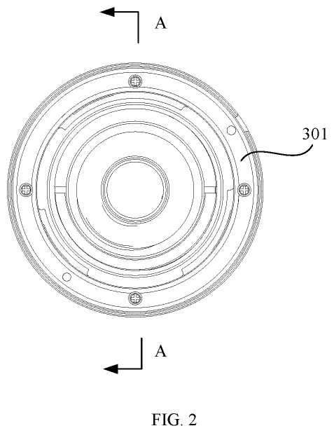

Referring to FIG. 1 to FIG. 3, in some embodiments, the present disclosure provides a lens adapter device 300 applied in a mobile phone high-definition photography system. The mobile phone high-definition photography system includes a mobile phone protective case 100 and a lens adapter ring 200. The mobile phone protective case 100 is configured to mount a mobile phone, and the lens adapter ring 200 is configured to connect a camera lens 500. The lens adapter device 300 includes a lens barrel 301, a first lens unit 310 disposed in the lens barrel 301, and a second lens unit 320 disposed in the lens barrel 301 and spaced apart from the first lens unit 310.

The lens barrel 301 has a first end 301a and a second end 301b disposed oppositely to each other. The first end 301a of the lens barrel 301 is detachably connected to the lens adapter ring 200, and the second end 301b of the lens barrel 301 is detachably connected to the mobile phone protective case 100.

An object-side surface of the first lens unit 310 is planar, and an image-side surface of the first lens unit 310 is convex.

An object-side surface of the second lens unit 320 is planar, and an image-side surface of the second lens unit 320 is concave.

In the embodiments, the lens barrel 301 is hollow cylindrical. In some embodiments, the lens barrel 301 is made of aluminum alloy, stainless steel, or high-strength engineering plastic, featuring lightweight, robust, and durable characteristics. In some embodiments, lens mounting structures such as positioning grooves, retaining rings, and anti-vibration pads are provided inside the lens barrel 301 to ensure that the lens units are stably mounted and precisely aligned with the optical axis X. In some embodiments, an inner wall of the lens barrel 301 is subjected to a matte finish to effectively prevent internal reflections and scattered light, thereby avoiding influence of stray light on imaging quality. In some embodiments, each of the first end 301a and the second end 301b is provided with a standard threaded interface. For example, the threaded interface at the first end 301a adopts the bayonet thread specification for the camera lens 500, and the threaded interface at the second end 301b matches the connecting thread of the mobile phone protective case 100.

The first lens unit 310 is mounted inside the lens barrel 301 and located close to the first end 301a, i.e., the object side OD of the lens adapter device. The object-side surface of the first lens unit 310 is planar, which reduces distortion of incident light and ensures that light exiting the camera lens enters the lens adapter device with minimal aberration. The image-side surface of the first lens unit 310 is convex, and is configured to preliminarily focus the light and control the divergence angle of the light beam, so as to suit the receiving characteristics of the mobile phone camera.

The second lens unit 320 is mounted inside the lens barrel 301 and located close to the second end 301b, i.e., the image side IM of the lens adapter device. The object-side surface of the second lens unit 320 is planar, configured to receive the light beam from the first lens unit 310 and maintain the accuracy of beam transmission. The image-side surface of the second lens unit 320 is concave, configured to compensate for spherical aberration introduced by the first lens unit 310, while controlling the degree of matching between the imaging plane and the sensor of the mobile phone camera, thereby ensuring a clear imaging effect.

During use, the first end 301a of the lens adapter device 300 is connected to the lens adapter ring 200, and the camera lens 500 (e.g., various lens models from brands such as Canon, Nikon, Sony, etc.) is mounted to the lens adapter ring 200. The second end 301b of the lens adapter device 300 is connected to the mobile phone protective case 100. Finally, the mobile phone is installed into the mobile phone protective case 100, completing the assembly of the entire system. It should be noted that the lens adapter ring 200 serving as an intermediate medium is merely by way of example. In some other embodiments, the lens adapter device 300 is directly connected to the camera lens 500.

When light passes through the camera lens 500, the optical path of the lens adapter device 300 is as follows. First, the light travels through the lens adapter ring 200 into the interior of the lens barrel 301 and reaches the planar object-side surface of the first lens unit 310. Because the camera lens 500 is designed for a larger sensor, the image plane it projects is significantly larger than the sensor of the mobile phone camera. Accordingly, an optical system is required for adjustment. After passing through the planar object-side surface of the first lens unit 310, the light reaches the convex image-side surface, where it is preliminarily focused. As a result, the divergence angle of the light beam is controlled within a range suitable for reception by the mobile phone camera.

Subsequently, the light passed from the first lens unit 310 continues forward and reaches the planar object-side surface of the second lens unit 320. The planar object-side surface of the second lens unit 320 ensures accurate beam transmission and reduces additional distortion that might arise during transmission. As the light passes through the second lens unit 320 and then exits through its concave image-side surface, the light beam is further corrected, in particular, high-order aberrations are compensated for, while the imaging plane is precisely adjusted to coincide with the focal plane of the sensor of the mobile phone camera. Finally, the optically adjusted light enters the mobile phone camera to form a clear image.

According to the present disclosure, the combined arrangement of the first lens unit 310 and the second lens unit 320 in the lens adapter device 300 solves the problem in the related art of incompatibility between a mobile phone lens and a camera lens 500. The first lens unit 310, configured with a planar object-side surface and a convex image-side surface, is configured for preliminary focusing and controlling the incident angle of the light beam, ensuring the accuracy of light introduction during photography. The concave image-side surface of the second lens unit 320 further receives and processes the light beam emitted from the first lens unit 310 to control higher-order aberrations, thus improving image quality.

The lens adapter device 300 provides an effective connection between the camera lens 500 and the mobile phone camera, overcoming the limitations of conventional mobile phone photography. Users can utilize various professional-grade lenses, such as wide-angle, telephoto, and macro lenses, for mobile phone photography, significantly enhancing the mobile phone's performance across different shooting scenarios. Notably, in low-light environments, the use of a large-aperture professional camera lens markedly improves the mobile phone's low-light imaging capability.

Moreover, the lens adapter device 300 features a simple structure and is easy to operate, delivering professional-grade shooting results without complex adjustment procedures. It not only ensures imaging quality in complex scenarios such as telephoto and macro photography, but also fully leverages the advantages of the camera lens 500, thus enhancing the professional performance of the mobile phone photography system.

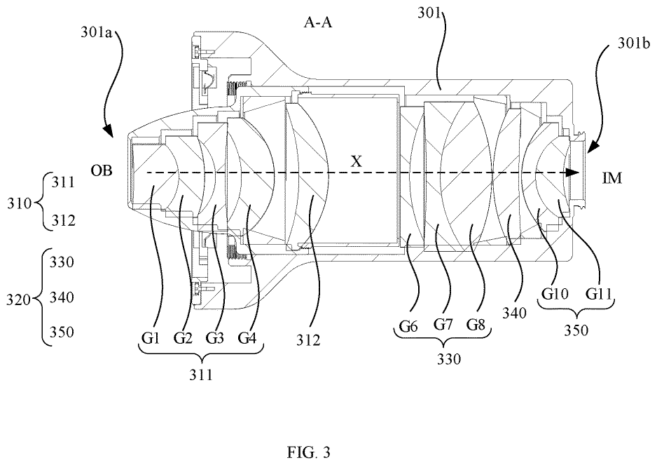

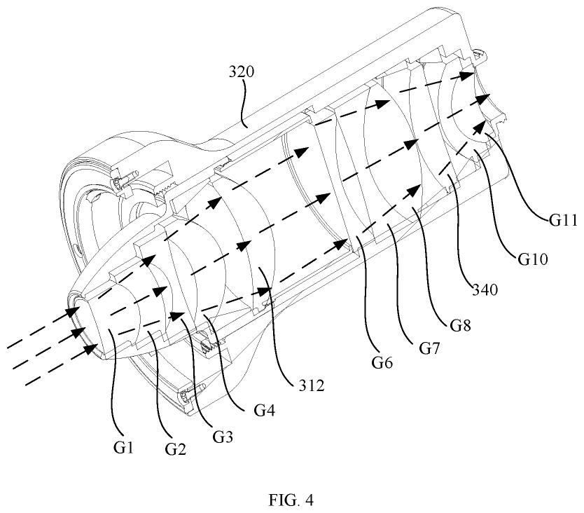

Referring to FIG. 3 and FIG. 4, in some embodiments, the first lens unit 310 and the second lens unit 320 are spaced apart from each other along a first direction, i.e., along an optical axis X of the lens adapter device.

The first lens unit 310 includes a first lens group 311 and a second lens group 312.

The first lens group 311 has a positive optical power. An object-side surface of the first lens group 311 is planar, and an image-side surface of the first lens group 311 is convex.

The second lens group 312 is disposed on the side of the first lens group 311 facing the image-side surface of the first lens group 311, and the second lens group 312 is spaced apart from the first lens group 311. The second lens group 312 has a negative optical power. An object-side surface of the second lens group 312 is concave, and an image-side surface of the second lens group 312 is convex.

The second lens unit 320 includes a third lens group 330, a fourth lens group 340, and a fifth lens group 350.

The third lens group 330 has a positive optical power. An object-side surface of the third lens group 330 is planar, and an image-side surface of the third lens group 330 is convex.

The fourth lens group 340 has a positive optical power. An object-side surface of the fourth lens group 340 is convex, and an image-side surface of the fourth lens group 340 is planar.

The fifth lens group 350 has a negative optical power. An object-side surface of the fifth lens group 350 is convex, and an image-side surface of the fifth lens group 350 is concave.

In the embodiments, the first lens unit 310 and the second lens unit 320 are spaced apart in the first direction, forming a complete optical system for achieving optical matching between the camera lens 500 and the mobile phone camera.

The first lens unit 310 includes the first lens group 311 and the second lens group 312 that cooperate to preliminarily receive and process light from the camera lens 500.

The first lens group 311 has the positive optical power for converging incident light. The planar object-side surface of the first lens group 311 reduces distortion and ensures that light rays from the camera lens 500 enter the lens adapter device 300 with minimal aberration. The convex image-side surface of the first lens group 311 converges the light transmitted through the planar object-side surface of the first lens group 311, preparing for subsequent optical processing.

The second lens group 312 is disposed on the side of the first lens group 311 facing the image-side surface of the first lens group 311, and the second lens group 312 is spaced apart from the first lens group 311. This provides a sufficient optical path distance between the first lens group 311 and the second lens group 312 to facilitate spatial propagation and modulation of light. The second lens group 312 has the negative optical power, producing a diverging effect on light that optically compensates for the converging effect of the first lens group 311. The object-side surface of the second lens group 312 is concave and is configured to receive converged light from the first lens group 311 and initiate its divergence. The image-side surface of the second lens group 312 is convex. This concave-convex (meniscus) configuration forms a negative lens group, primarily configured to correct spherical aberration and chromatic aberration while controlling the exit angle of the light beam.

The second lens unit 320 includes the third lens group 330, the fourth lens group 340, and the fifth lens group 350 that are arranged sequentially, forming an optical modulation mechanism for adjusting light to match the sensor characteristics of the mobile phone camera.

The third lens group 330 has the positive optical power for converging incident light. The planar object-side surface of the third lens group 330 receives light from the first lens unit 310 with minimal additional optical path disturbance. The convex image-side surface of the third lens group 330 re-converges the light, initiating a second stage of optical modulation.

The fourth lens group 340 has the positive optical power, continuing the converging function of the third lens group 330 and further enhancing convergence. The convex object-side surface of the fourth lens group 340 optically couples with the convex image-side surface of the third lens group 330 to increase converging capability. The planar image-side surface of the fourth lens group 340 ensures that the converging beam maintains a good phase plane upon exit, thereby reducing wavefront distortion.

The fifth lens group 350 has the negative optical power for diverging incident light. The convex object-side surface of the fifth lens group 350 receives light converged by the preceding two lens groups. The concave image-side surface of the fifth lens group 350 forms a typical negative lens for finally adjusting the light beam at the last optical path stage. The image-side surface of the fifth lens group 350 is further configured to precisely control the focal plane position to accurately match the sensor plane of the mobile phone camera, while compensating for residual system aberrations.

When light passes through the camera lens 500, it travels through the lens adapter ring 200 into the interior of the lens barrel 301 and reaches the first lens group 311 of the first lens unit 310. Since the object-side surface of the first lens group 311 is planar, the light undergoes almost no refraction, thereby preserving the original imaging information. When light passes through the convex image-side surface of the first lens group 311, it starts to converge, and the beam angle deflects toward the optical axis X.

Subsequently, the light that has undergone initial convergence continues forward and reaches the concave object-side surface of the second lens group 312, where it begins to diverge moderately under the negative lens effect. This diverging effect is primarily configured to correct spherical aberration and chromatic aberration while controlling the field of view. As the light passes through the convex image-side surface of the second lens group 312, the beam is further adjusted so that its divergence degree is maintained within an appropriate range, thereby preparing it for subsequent optical path processing.

After exiting the first lens unit 310, the light enters the second lens unit 320 and first reaches the planar object-side surface of the third lens group 330. The planar object-side design ensures the stability of beam transmission and reduces additional distortion. When the light passes through the convex image-side surface of the third lens group 330, a converging effect is generated again, and the beam angle once again deflects toward the optical axis X.

Next, the light enters the convex object-side surface of the fourth lens group 340, further enhancing the converging effect. After passing through the planar image-side surface of the fourth lens group 340, the highly converged beam exits the fourth lens group 340 with a well-maintained phase plane, ready for final optical adjustment.

Finally, the light reaches the convex object-side surface of the fifth lens group 350 for final adjustment before imaging. When passing through the concave image-side surface of the fifth lens group 350, the light undergoes moderate divergence due to the negative lens effect. This final diverging action precisely controls the focal plane position, accurately aligning the imaging plane with the mobile phone camera sensor while compensating for residual aberrations in the entire optical system.

Through the cooperation of the five lens groups, light from the camera lens 500, after appropriate optical modulation, ultimately forms a clear, color-accurate, and high-quality image on the sensor of the mobile phone camera, thereby achieving compatibility between the camera lens and the mobile phone photography system.

With reference to FIG. 3, in some embodiments, the first lens unit 310 includes two lens groups, and the second lens unit 320 includes three lens groups.

The total number of lenses of the first lens unit 310 and the second lens unit 320 is five; or, the total number of lenses of the first lens unit 310 and the second lens unit 320 is eleven.

In the embodiments, the first lens unit 310 includes two lens groups, and the second lens unit 320 includes three lens groups, collectively forming a complete optical adapter system. The first lens unit 310 includes the first lens group 311 and the second lens group 312; and the second lens unit 320 includes the third lens group 330, the fourth lens group 340, and the fifth lens group 350.

The embodiments provide two configurations regarding the number of lenses. In some embodiments, the total number of lenses in the first lens unit 310 and the second lens unit 320 is five. In this configuration, each lens group is substantially composed of a single lens, forming a concise optical system. This is suitable for application scenarios where size and cost are highly constrained, achieving a lightweight and compact structure while maintaining basic optical performance.

In some other embodiments, the total number of lenses in the first lens unit 310 and the second lens unit 320 is eleven. In this configuration, some lens groups may employ a compound lens design, such as a doublet or triplet lens, forming a more complex optical system. This is suitable for professional application scenarios that demand high imaging quality, as it can more effectively correct various optical aberrations, including chromatic aberration, spherical aberration, coma, and astigmatism, thus providing higher-quality imaging effects.

An appropriate configuration can be selected according to actual needs. The first configuration is concise and economical, suitable for everyday shooting. The second configuration offers superior performance, suitable for professional photography creation. Regardless of which configuration is selected, the lens adapter device of the present disclosure can effectively achieve optical matching between the camera lens 500 and the mobile phone camera, greatly enhancing the professional performance of the mobile phone photography system.

Referring to FIG. 3 and FIG. 4, in the embodiments, the first lens group 311 includes a first lens G1, a second lens G2, a third lens G3, and a fourth lens G4 arranged sequentially from the object side to the image side.

An object-side surface of the first lens G1 is planar, and an image-side surface of the first lens G1 is convex and configured with a radius of curvature R1. The planar object-side surface of the first lens G1 allows light from the camera lens to enter the system directly without additional refractive interference, thereby preserving the original imaging information. The convex image-side surface of the first lens G1 initiates preliminary convergence modulation of the light.

An object-side surface of the second lens G2 is concave and configured with a radius of curvature R2, and an image-side surface of the second lens G2 is convex and configured with a radius of curvature R3. This concave-convex configuration forms a typical negative lens, which corrects chromatic aberration and spherical aberration.

An object-side surface of the third lens G3 is concave and configured with a radius of curvature R4, and an image-side surface of the third lens G3 is planar. The concave object-side surface of the third lens G3 continues modulating the light, and the planar image-side surface of the third lens G3 ensures that the light exits with a favorable phase.

An object-side surface of the fourth lens G4 is concave and configured with a radius of curvature R5, and an image-side surface of the fourth lens G4 is convex and configured with a radius of curvature R6. The fourth lens G4 further finely adjusts the light, for example, compensate for light rays at the edges of the field of view.

The first lens G1, the second lens G2, the third lens G3, and the fourth lens G4 are arranged sequentially in contact with one another, which forms a gapless optical mechanism for reducing interface reflection and scattering, thereby improving the optical efficiency. The first lens G1, the second lens G2, the third lens G3, and the fourth lens G4 have effective optical diameters OD1, OD2, OD3, and OD4, respectively, satisfying OD1<OD2<OD3<OD4 (e.g., OD1=10 mm, OD2=15 mm, OD3=20 mm, OD4=25 mm). This gradually increased diameter configuration ensures that no aperture limitation occurs during beam propagation, thereby guaranteeing imaging quality at the edge of the field of view.

In the embodiments, the magnitudes of the radii of curvature satisfy R1<R2<R3<R4<R5<R6. This progressively increased configuration of radii of curvature has significant optical implications.

For example, R1=10 mm, R2=15 mm, R3=20 mm, R4=25 mm, R5=30 mm, R6=35 mm. In this configuration, light first undergoes significant refraction at the surface with a strong curvature (R1), and then passes through successively weaker refraction effects (R2 to R6), achieving a smooth transition of light, effectively reducing aberration accumulation, and exhibiting excellent control over high-order aberrations.

For another example, R1=8 mm, R2=12 mm, R3=18 mm, R4=24 mm, R5=32 mm, R6=40 mm. In this configuration, the strong refraction at the front surface and the weak refraction at the rear surface create a greater contrast, which is suitable for controlling peripheral light rays of the camera lens 500 with a large aperture, thereby improving resolution at the edge of the field of view.

This progressive arrangement of radii of curvature creates a focal power distribution that transitions from strong to weak, allowing light to undergo appropriate refraction at different surfaces and thereby achieving ideal optical path control. This is suitable for re-projecting an image from a large-field-of-view camera lens 500 onto a smaller mobile phone sensor, as it can effectively preserve the field of view of the original image while controlling various aberrations.

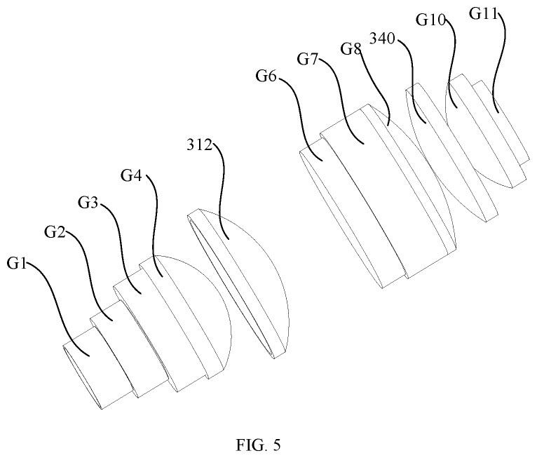

Referring to FIG. 3 to FIG. 5, in the embodiments, the second lens group 312 includes a fifth lens spaced apart from the fourth lens G4.

An object-side surface of the fifth lens is concave and configured with a radius of curvature R7, and an image-side surface of the fifth lens is convex and configured with a radius of curvature R8. The fifth lens has an effective optical diameter OD5, satisfying OD5>OD4.

In the embodiments, the second lens group 312 includes the fifth lens spaced apart from the fourth lens G4 of the first lens group 311. This spacing creates an air gap that provides an appropriate propagation distance for light between the two lens groups, facilitating beam shaping and modulation. The presence of such an air gap introduces an additional degree of design freedom for the entire optical system.

The fifth lens has the concave object-side surface with the radius of curvature R7 and the convex image-side surface with the radius of curvature R8. This concave-convex configuration forms a typical negative lens that diverges the light beam passing through the first lens group 311, controls the convergence angle of the light, and corrects spherical and chromatic aberrations introduced by the first lens group 311. Additionally, this configuration adjusts the position of the imaging plane to match the subsequent optical path, expands the effective field of view, and increases imaging coverage.

The effective optical diameter OD5 of the fifth lens is greater than the effective optical diameter OD4 of the fourth lens G4. From a ray tracing perspective, after the light beam passes through the first lens group 311, the diverging effect of the negative lens increases the beam diameter. Accordingly, the fifth lens requires a larger effective optical diameter to fully receive all light rays exited from the first lens group 311, thereby preventing beam clipping that may cause vignetting or shading.

For example, OD4=15 mm, OD5=18 mm, R7=40 mm, and R8=45 mm. In this configuration, the fifth lens has a diameter margin of 3 mm, which is sufficient to receive marginal light rays, ensuring vignetting-free imaging across the entire field of view. Further, the radii of curvature R7 and R8 provide a moderate negative optical power, precisely modulating the light beam from the first lens group 311.

In some embodiments, the fifth lens is made of an optical glass having a high dispersion ratio (e.g., SF series), which more effectively corrects chromatic aberration of the system and thereby improving the color reproduction capability of the imaging.

In summary, the second lens group 312 and the first lens group 311 cooperates to convert the imaging characteristics of the camera lens 500 into optical characteristics suitable for the mobile phone camera.

Referring to FIG. 3 to FIG. 5, in the embodiments, the third lens group 330 includes a sixth lens G6, a seventh lens G7, and an eighth lens G8 arranged sequentially from the object side to the image side.

An object-side surface of the sixth lens G6 is planar, and an image-side surface of the sixth lens G6 is concave and configured with a radius of curvature R9. The sixth lens G6 has an effective optical diameter OD6. The planar object-side surface of the sixth lens G6 allows light from the second lens group 312 to enter the third lens group 330 with minimal interface variation, thereby reducing interface reflection and scattering. The concave image-side surface of the sixth lens G6 performs preliminary negative refractive modulation on the incident light beam, initiating fine control over the propagation path of the light.

An object-side surface of the seventh lens G7 is planar, and an image-side surface of the seventh lens G7 is concave and configured with a radius of curvature R10. The seventh lens G7 has an effective optical diameter OD7, which satisfies OD7=OD6. This equal-diameter configuration provides optical continuity with the sixth lens G6, and the two consecutive planar-concave configuration form an enhanced negative lens combination. The matched radial dimensions facilitate optical processing and assembly while ensuring that no unintended aperture effects occur during beam transmission due to changes in lens size.

An object-side surface of the eighth lens G8 is convex and configured with a radius of curvature R11, and an image-side surface of the eighth lens G8 is convex and configured with a radius of curvature R12. The eighth lens G8 has an effective optical diameter OD8 satisfying OD8=OD7. This biconvex configuration forms a typical positive lens that converges and modulates the diverging light beam from the preceding two lenses, thereby returning the optical path to the intended propagation direction. This three-lens equal-diameter configuration (OD6=OD7=OD8) provides radial dimensional uniformity, providing good structural stability and optical consistency to the entire third lens group 330.

The object-side surface of the sixth lens G6 is spaced apart from the image-side surface of the fifth lens, defining an air gap between the second lens group 312 and the third lens group 330. This air gap serves as an important optical boundary. The sixth lens G6, the seventh lens G7, and the eighth lens G8 are arranged in contact with one another, forming a gapless compound lens group. This close-contact configuration reduces interface reflection, increases light transmittance, and enhances the mechanical stability of the lens group.

Further, the two consecutive negative lenses (the sixth lens G6 and the seventh lens G7) effectively control spherical and chromatic aberrations. In particular, they further optimize the aberration distribution of the light beam exited from the second lens group 312 after preliminary modulation. Subsequently, the final positive lens (the eighth lens G8) moderately converges the divergent light beam, thereby providing suitable incident conditions for the following lens group.

This compound lens group configuration offers several advantages. First, the close-contact arrangement of three lenses with equal diameters simplifies processing and assembly, thereby reducing manufacturing costs. Second, the two-negative-one-positive optical configuration provides excellent aberration balancing capability, ensuring the imaging quality of the entire lens adapter device.

Referring to FIG. 3 to FIG. 5, in some embodiments, the fourth lens group 340 includes a ninth lens. An object-side surface of the ninth lens is convex and configured with a radius of curvature R13, and an image-side surface of the ninth lens is planar. The object-side surface of the ninth lens is in contact with the image-side surface of the eighth lens G8. The ninth lens has an effective optical diameter smaller than that of the eighth lens G8.

In the embodiments, the fourth lens group 340 employs a single-lens structure, including the ninth lens. The object-side surface of the ninth lens is convex and configured with the radius of curvature R13, and the image-side surface is planar, forming a typical positive lens for converging the light beam.

The object-side surface of the ninth lens is in contact with the image-side surface of the eighth lens G8, eliminating the air gap between the two lenses. This reduces interface reflection and scattering while improving optical efficiency. Moreover, this close-contact arrangement allows the eighth lens G8 and the ninth lens to effectively form a compound positive lens group, in which the two lenses work in coordination to jointly achieve precise convergence control over the light rays.

Further, the effective optical diameter of the ninth lens is smaller than that of the eighth lens G8. This reduces the influence of marginal stray light on imaging quality, optimizes depth-of-field performance, and improves central resolution. Additionally, it reduces the optical burden on subsequent lens groups, simplifies system design, and further controls the field of view to better match the receiving characteristics of the mobile phone camera.

The design with this relatively small optical diameter essentially allows the ninth lens to serve a dual role as both a lens and an aperture stop in the optical system, providing refractive modulation of the light rays while controlling the beam diameter.

Referring to FIG. 3 and FIG. 4, in the embodiments, the fifth lens group 350 is a cemented lens. An object-side surface of the cemented lens is convex, and an image-side surface of the cemented lens is concave. The cemented lens is configured to focus the light beam onto a common plane. The fifth lens group 350 has an effective optical diameter smaller than the effective optical diameter of the fourth lens group 340.

In the embodiments, the fifth lens group 350 is a cemented lens formed by two lenses (designated G10 and G11) bonded together with optical adhesive. The cemented lens has a convex object-side surface and a concave image-side surface, forming a typical convex-concave configuration. This cemented lens is positioned at the very end of the entire lens adapter device and mounted directly at the location closest to the mobile phone, and serves as the last optical element before light enters the mobile phone camera.

The cemented lens effectively corrects chromatic aberration. For instance, when the two lenses are made of optical materials with different refractive indices and dispersion rates, an excellent achromatic performance is achieved. Furthermore, the convex-concave configuration provides a unique optical combination that possesses both converging and diverging characteristics, allowing precise control of the final imaging plane.

The fifth lens group 350 is configured to focus the light beam onto a common plane, ensuring that light emitted from the camera lens 500 and modulated by the preceding lens groups ultimately form a clear image on the sensor plane of the mobile phone camera. This plane-focusing capability is critical for eliminating field curvature and ensuring uniform sharpness across the entire field of view.

Further, the effective optical diameter of the fifth lens group 350 is smaller than that of the fourth lens group 340. This configuration controls the range of the light beam entering the mobile phone camera, avoids aberrations and stray light caused by marginal rays, and improves imaging quality in the central region. Thus, as the final optical element, the fifth lens group 350 serves as a tuning element that performs final fine adjustments on the light rays processed by all preceding lens groups, ensuring that the output beam of the entire lens adapter device 300 perfectly matches the receiving characteristics of the mobile phone camera.

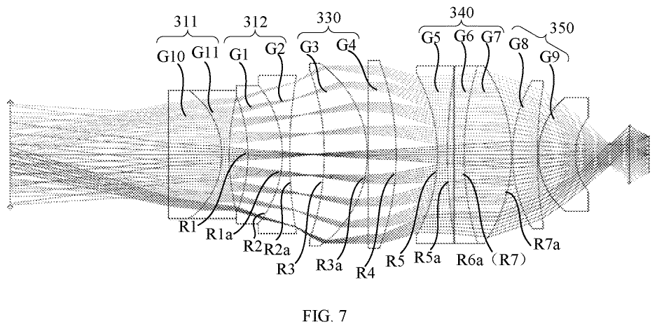

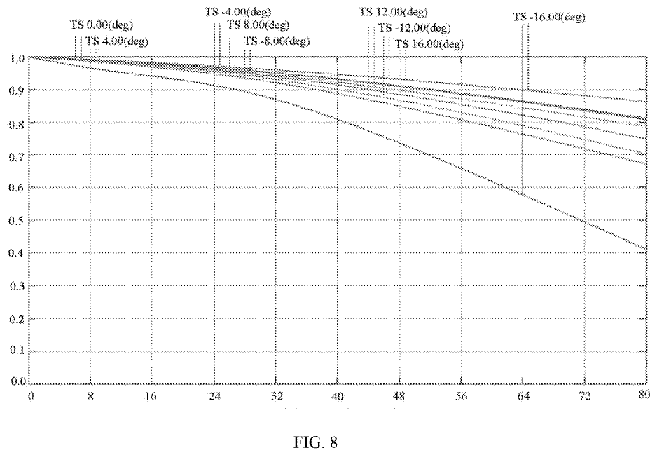

Referring to FIG. 7 to FIG. 8, the present disclosure further provides a lens adapter device, including a lens barrel 301 and a lens group disposed within the lens barrel 301. The lens group includes a first lens group 311, a second lens group 312, a third lens group 330, a fourth lens group 340, and a fifth lens group 350 sequentially arranged along the optical axis X from the object side to the image side of the lens adapter device.

The first lens group 311 has a negative optical power. An image-side surface of the first lens group 311 is concave.

The second lens group 312 has a negative optical power. An object-side surface and an image-side surface of the second lens group 312 are both concave.

The third lens group 330 has a positive optical power. An object-side surface of the third lens group 330 is concave, and an image-side surface of the third lens group 330 is convex.

The fourth lens group 340 has a negative optical power. An object-side surface of the fourth lens group 340 is concave, and an image-side surface of the fourth lens group 340 is spherical.

The fifth lens group 350 has a negative optical power. An object-side surface of the fifth lens group 350 is convex, and an image-side surface of the fifth lens group 350 is concave.

A focal length of the lens adapter device is recorded as f, an effective focal length of the second lens group 312 is recorded as f2, an effective focal length of the third lens group 330 is recorded as f3, and an effective focal length of the fourth lens group 340 is recorded as f4. The following relationships are satisfied:

$$0.1 < \vert f / f 2 \vert < 0. 3 ; 0 \text{.4} < \vert f / f 3 \vert < 0.6 ; and 0.03 < \vert f / f 4 \vert < 0.06 ;$$

In the embodiments, the focal length f of the lens adapter device is 12.88 mm, the effective focal length f1 of the first lens group 311 is −291.36 mm, the effective focal length f2 of the second lens group 312 is −58.6 mm, the effective focal length f3 of the third lens group 330 is −26.78 mm, and the effective focal length f4 of the fourth lens group 340 is −294.86 mm. Through calculation with actual parameters, |f/f2|=0.22, |f/f3|=0.48, and |f/f4|−0.044, satisfying the relational condition of the design requirements.

The lens adapter device is configured for high-quality reduction conversion from an image plane of a professional camera lens to a mobile phone sensor. For instance, a camera lens is typically designed for a full-frame sensor (36×24 mm), whereas a mobile phone sensor measures approximately 6×4.5 mm, requiring a reduction ratio of about 6:1. The lens adapter device achieves this by employing a negative-negative-positive-negative-negative optical power arrangement and a staged beam control approach.

The first lens group 311 has weak negative optical power (f1=−291.36 mm) and serves as the beam receiving end of the entire system. In the embodiments, the first lens group 311 receives the exited beam from the camera lens and preliminarily controls beam divergence. Owing to its large absolute focal length and relatively weak focal power, the first lens group 311 handles the incident beam gently, avoiding the introduction of excessive higher-order aberrations. The concave image-side surface of the first lens group 311 helps control spherical aberration, and through optimization with appropriate aspheric coefficients, it creates favorable optical conditions for subsequent lens groups.

The second lens group 312 is configured for beam divergence and aberration correction. The second lens group 312 has the negative optical power (f2=−58.6 mm) that is stronger than that of the first lens group 311. The condition 0.1<|f/f2|<0.3 ensures a moderate divergence degree, effectively controlling the beam angle while avoiding energy loss and image degradation caused by excessive divergence. The biconcave configuration further enhances the divergence effect. Moreover, through surface shape control, the second lens group 312 effectively corrects aberrations originating from the original lens, including spherical aberration, coma, and astigmatism. The actual calculated value |f/f2|=0.22 falls within the optimal range, indicating that the second lens group 312 achieves ideal beam divergence control and aberration correction.

The third lens group 330 is configured for beam control and image plane reduction. Although its effective focal length is negative (f3=−26.78 mm), the configuration of the concave object-side surface and the convex image-side surface allows the third lens group 330 to achieve an optical effect similar to that of a positive optical power in a complex optical system. The condition 0.4<|f/f3|<0.6 ensures that the third lens group 330 optically cooperates with the preceding and subsequent lens groups to achieve geometric reduction of the image plane through beam trajectory control. The actual calculated value |f/f3|=0.48 lies at the center of the optimal range, indicating that this lens group effectively balances the relationship between beam propagation and imaging quality, thereby maintaining excellent imaging performance while achieving the reduction ratio.

The third lens group 330 is configured for beam control and image plane reduction. Although the third lens group 330 has the negative effective focal length (f3=−26.78 mm), the concave object-side surface and the convex image-side surface of the third lens group 330 enable it to achieve an optical effect similar to positive optical power in a complex optical system. The condition 0.4<|f/f3|<0.6 ensures that the third lens group 330 optically cooperates with adjacent lens groups to achieve geometric image plane reduction via beam trajectory control. The actual calculated value |f/f3|=0.48 lies at the center of the optimal range, indicating that the third lens group 330 effectively balances beam propagation and imaging quality, thereby maintaining excellent imaging performance while achieving the required reduction ratio.

The fourth lens group 340 has the negative optical power (f4=−294.86 mm) and cooperates optically with the third lens group 330. The condition 0.03<|f/f4|<0.06 ensures that the fourth lens group 340 provides a moderate negative optical power, effectively correcting residual aberrations without excessively diverging the beam and compromising final image quality. The actual calculated value |f/f4|=0.044 falls within the design range, indicating that the fourth lens group 340 effectively corrects aberrations and flattens the image plane. The concave object-side surface of the fourth lens group 340 controls the propagation angle of the incident beam, and the spherical image-side surface of the fourth lens group 340 provides gentle aberration correction, particularly for spherical aberration and coma.

The fifth lens group 350 serves as the final adjustment component of the system. The fifth lens group 350 has the negative optical power and is configured for beam shaping and final aberration correction. The convex-concave configuration of the fifth lens group 350 effectively corrects residual system aberrations, particularly chromatic aberration, distortion, and astigmatism, thereby ensuring image plane flatness and accurate color reproduction in the final image.

That is, the first lens group and the second lens group are configured for initial beam divergence and aberration correction. The third lens group 330 serves as a key beam control component, achieving the primary image plane reduction function through a specific optical design. The fourth lens group and the fifth lens group are configured for fine aberration correction and beam shaping.

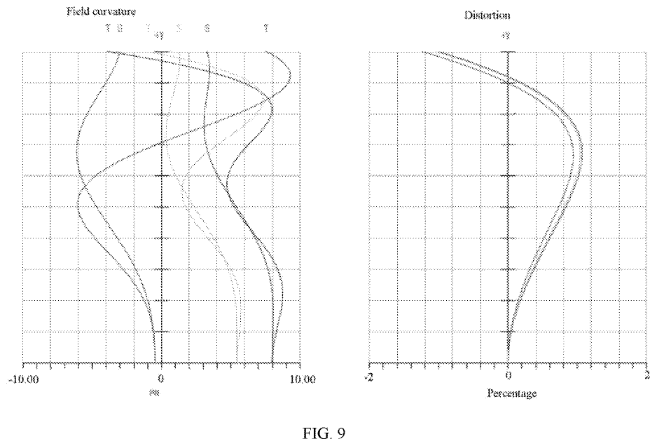

Referring to FIG. 9, optical simulation analysis verifies that the lens adapter device achieves excellent optical performance across an operating field of view of up to 16 degrees. Field curvature analysis shows that the sagittal field curvature is controlled within 0.0052 mm and the meridional field curvature within 0.0083 mm, demonstrating the effectiveness of the focal power configuration of each lens group and the associated conditional expressions. The ratio values |f/f2|=0.22 for the second lens group 312 and |f/f3|=0.48 for the third lens group 330 enable smooth beam conversion and precise aberration control, bringing the image plane flatness of the entire system to a professional-grade level.

Distortion analysis indicates that the maximum distortion of the system is 2.0888%. This low distortion characteristic directly results from the condition |f/f4|=0.044 for the fourth lens group 340, ensuring that the fourth lens group effectively corrects residual aberrations from the first three lens groups. The consistency of field curvature across different wavelengths (0.6560 μm, 0.5870 μm, and 0.4860 μm) further underscores the important role of the fifth lens group 350 in chromatic aberration correction, ensuring that the color reproduction capability of the camera lens is fully transferred to the mobile phone sensor.

Referring to FIG. 7, in some embodiments, the second lens group 312 includes a first lens G1 and a second lens G2 arranged along the optical axis X from the object side OD to the image side IM.

The first lens G1 has a negative optical power. A paraxial radius of curvature of an object-side optical surface of the first lens G1 is recorded as R1, and a paraxial radius of curvature of an image-side surface of the first lens G1 is recorded as R1a.

The second lens G2 has a negative optical power. A paraxial radius of curvature of an object-side surface of the second lens G2 is recorded as R2, and a paraxial radius of curvature of an image-side surface of the second lens G2 is recorded as R2a.

The following relations are satisfied:

$$1 < \vert R 1 / R 1 a \vert < 1.4 ; and$$

$$0.2 < \vert R 2 / R 2 a \vert < 0.4 .$$

In the embodiments, the second lens group 312 includes the first lens G1 and the second lens G2. The object-side surface of the first lens G1 has the radius of curvature R1=−31.32 mm, and the image-side surface of the first lens G1 has the radius of curvature R1a=−22.69 mm. The object-side surface of the second lens G2 has the radius of curvature R2=−22.69 mm, and the image-side surface of the second lens G2 has the radius of curvature R2a=95.04 mm. Based on actual parameter calculations, |R1/R1a|=|−31.32/(−22.69) |=1.38, which falls within the required range of 1 to 1.4; R2/R2a|=|−22.69/95.04|=0.24, which falls within the required range of 0.2 to 0.4.

The conditional expression 1<|R1/R1a|<1.4 is critical to the optical performance of the first lens G1. The first lens G1 serves as a front component of the second lens group 312. The curvature radius ratio of its object-side surface to its image-side surface directly influences beam divergence and aberration correction. When the ratio R1/R1a| is controlled within the range of 1 to 1.4, the first lens G1 exhibits a moderate biconcave characteristic, where the absolute curvature radius of the object-side surface is slightly larger than that of the image-side surface. This asymmetric curvature distribution helps optimize beam divergence. The actual ratio |R1/R1a|=1.38 is at the higher end of the range, indicating that the object-side surface of the first lens G1 has a relatively gentle curvature, thereby receiving the light beam from the first lens group 311 mildly, avoiding excessive abrupt beam deflection, and effectively controlling spherical aberration and coma. If the ratio is less than 1, the image-side surface curvature becomes too large, causing excessive beam divergence and aberration deterioration. If the ratio exceeds 1.4, the object-side surface becomes too flat to provide sufficient divergence, adversely affecting the optical performance of the entire system.

The conditional expression 0.2<|R2/R2a|<0.4 is critical to the optical performance of the second lens G2. The second lens G2 performs the primary divergence function of the second lens group 312, and the curvature radius ratio of its object-side to its image-side surfaces determines the final divergence state of the light beam. The actual ratio |R2/R2a|=0.24 lies at the lower end of the range, indicating that the image-side surface of the second lens G2 has a relatively large radius of curvature, exhibiting a weak concave characteristic, while the object-side surface remains strongly concave. This allows the second lens G2 to provide the necessary divergence while controlling the divergence degree via its gentle image-side surface, avoiding light energy loss from excessive divergence. The ratio is controlled within the range of 0.2 to 0.4, which ensures that the second lens G2 achieves good optical cooperation with the first lens G1, thereby realizing the optimal divergence effect of the entire second lens group 312.

The first lens G1 has the radii of curvature R1=−31.32 mm and R1a=−22.69 mm, both of which are negative, indicating that the first lens G1 is a biconcave lens. The significant difference between the two radii of curvature provides an asymmetric configuration that helps optimize beam propagation. The configuration of the second lens G2 is even more distinctive, with R2=−22.69 mm and R2a=95.04 mm. The object-side surface of the second lens G2 shares the same radius of curvature as the image-side surface of the first lens G1, achieving an optical matching effect, while the large radius of curvature (95.04 mm) of the image-side surface of the second lens G2 provides a relatively gentle beam exit condition.

The first lens G1 is primarily configured for initial beam divergence and preliminary aberration correction. The moderate curvature ratio of the first lens G1 ensures a smooth beam transition from the first lens group 311 to the second lens group 312. The second lens G2 is primarily configured for main divergence, and the smaller curvature ratio of the second lens G2 enables the beam to reach a desired divergence state after passing through G2, thereby providing suitable beam conditions for the subsequent third lens group 330. The curvature ratios of the first lens G1 and the second lens G2 are controlled within respective optimal ranges, ensuring that the entire second lens group 312 achieves its intended optical functions while maintaining good aberration correction performance.

The first lens G1, with the curvature ratio |R1/R1a|=1.38, effectively controls spherical aberration. The relatively gentle object-side curvature of the first lens G1 reduces higher-order spherical aberration, while the stronger image-side curvature of the first lens G1 ensures necessary beam deflection. The second lens G2, with the curvature ratio |R2/R2a|=0.24, is primarily configured for correcting coma and astigmatism. The strongly concave object-side surface of the second lens G2 effectively processes the beam from the first lens G1, and the relatively gentle image-side surface of the second lens G2 helps control coma generation.

Referring to FIG. 7, in the embodiments, the third lens group 330 includes a third lens G3 and a fourth lens G4 along the optical axis X from the object side OD to the image side IM.

The third lens G3 has a positive optical power. An object-side surface of the third lens G3 is concave, and an image-side surface of the third lens G3 is convex.

The fourth lens G4 has a positive optical power. An object-side surface of the fourth lens G4 is planar, and an image-side surface of the fourth lens G4 is convex.

A paraxial radius of curvature of the object-side surface of the third lens G3 is recorded as R3, a paraxial radius of curvature of the image-side surface of the third lens G3 is recorded as R3a, and a paraxial radius of curvature of the image-side surface of the fourth lens G4 is recorded as R4a. The following relations are satisfied:

$$2. < \vert R 3 / R 3 a \vert < 2.6 ; and$$

$$45 < \vert R 4 a \vert < 65 .$$

In the embodiments, the third lens group 330 includes the third lens G3 and the fourth lens G4. The object-side surface of the third lens G3 has a radius of curvature R3=−51.42 mm, the image-side surface of the third lens G3 has a radius of curvature R3a=22.59 mm, and the image-side surface of the fourth lens G4 has a radius of curvature R4a=−54.47 mm. Based on actual parameter calculations, |R3/R3a|=|−51.42/22.59|=2.28, which falls within the required range of 2.0 to 2.6; |R4a|=|−54.47|=54.47, which falls within the required range of 45 to 65.

The condition 2.0<|R3/R3a|<2.6 reflects the optical configuration of the third lens G3 as a positive-power meniscus lens. The third lens G3 is configured in a meniscus shape with a concave object-side surface (R3=−51.42 mm) and a convex image-side surface (R3a=22.59 mm). The actual value |R3/R3a|=2.28 lies in the medium-to-high range of the interval, indicating that the radius of curvature of the concave object-side surface is approximately 2.28 times that of the convex image-side surface. This proportional relationship ensures that the third lens G3 provides positive optical power while effectively controlling spherical aberration and coma.

When the ratio is controlled within the range of 2.0 to 2.6, the third lens G3 provides optimal beam convergence while achieving favorable aberration correction. If the ratio falls below 2.0, the concave object-side surface becomes excessively curved, leading to excessive beam deflection and increased higher-order spherical aberration, which degrades image quality. If the ratio exceeds 2.6, the concave object-side surface is relatively too flat and lacks sufficient beam control capability, which may degrade the overall optical performance of the system. The actual value of 2.28 strikes a precise balance between beam convergence and aberration control, ensuring that the third lens G3 delivers optimal optical performance within a complex multi-lens system.

The fourth lens G4 has the planar object-side surface and the convex image-side surface. The planar object-side surface simplifies beam incidence, and the convex image-side surface provides necessary beam convergence and aberration correction. With |R4a|=54.47, which falls near the middle of the specified range, the convex image-side surface exhibits a moderate curvature that delivers the required positive optical power without compromising aberration correction.

The radius of curvature is controlled within a range of 45 mm to 65 mm, ensuring favorable optical matching between the fourth lens G4 and the third lens G3, and enabling optimal convergence performance for the entire third lens group 330. The value of 54.47 mm allows the fourth lens G4 to achieve the necessary convergence while maintaining excellent aberration correction.

In some embodiments, a length of the lens adapter device along the optical axis X is recorded as L, an axial distance from the image-side surface of the second lens G2 to the object-side surface of the third lens G3 is recorded as T1, and an axial distance from the image-side surface of the third lens G3 to the object-side surface of the fourth lens G4 is recorded as T2. The following relationships are satisfied:

$$0.04 < T 1 / L < 0.08 ; and$$

$$30 < T 1 / T 2 < 40 .$$

In the embodiments, the condition 0.04<T1/L<0.08 controls the ratio of the axial distance T1 between the second lens group 312 and the third lens group 330 to the overall length L of the lens adapter device. When the ratio T1/L is controlled within the range of 0.04 to 0.08, it not only ensures sufficient optical space for the beam to transition from the negative optical power mechanism to the positive optical power mechanism, but also meets the compactness requirements of the lens adapter device. The length L of the lens adapter device is 129.43 mm, the axial distance T1 from the image-side surface of the second lens G2 to the object-side surface of the third lens G3 is 7.2 mm, and T2 is 0.2. If the ratio T1/L falls below 0.04, the gap between the second lens G2 and the third lens G3 becomes too small. The beam then lacks adequate propagation space during its transition from divergence to convergence, potentially causing abrupt beam deflection, increased aberrations, and affecting the overall focal length control of the optical system. If the ratio T1/L exceeds 0.08, the inter-group spacing becomes too large. Although this may facilitate a smooth beam transition, it increases the total length of the lens adapter device, which is disadvantageous for compact design and may also adversely impact mechanical stability and manufacturing cost.

Thus, the condition 30<T1/T2<40 defines the ratio between the inter-group spacing and the intra-lens spacing. When the ratio T1/T2 is controlled within the range of 30 to 40, it provides sufficient space between the second lens group 312 and the third lens group 330 for beam divergence-to-convergence transition, while maintaining close optical coupling between the lenses within the third lens group G3.

The relatively large distance T1 provides sufficient space for the beam state transition, allowing the divergent beam from the second lens group 312 to transition smoothly into the third lens group 330, thereby avoiding aberrations caused by abrupt beam changes. The relatively small distance T2 ensures close optical interaction between the two lenses inside the third lens group 330, enabling the third lens G3 and the fourth lens G4 to achieve effective optical coupling, collectively fulfilling the overall optical function of the third lens group 330. The fourth lens group 340 includes a fifth lens G5, a sixth lens G6, and a seventh lens G7 arranged along the optical axis X from the object side OD to the image side IM.

The fifth lens G5 has a positive optical power. An object-side surface and an image-side surface of the fifth lens G5 are both concave.

The sixth lens G6 has a negative optical power. An image-side surface of the sixth lens G6 is concave.

The seventh lens G7 has a positive optical power. An object-side surface and an image-side surface of the seventh lens G7 are both convex.

A paraxial radius of curvature of the object-side surface of the fifth lens G5 is recorded as R5, a paraxial radius of curvature of the image-side surface of the fifth lens G5 is recorded as R5a, a paraxial radius of curvature of the image-side surface of the sixth lens G6 is recorded as R6a, a paraxial radius of curvature of the object-side surface of the seventh lens G7 is recorded as R7, and a paraxial radius of curvature of the image-side surface of the seventh lens G7 is recorded as R7a. The following conditions are met:

$$0.25 < \vert R 5 / R 5 a \vert < 0.4 ; 1.7 < \vert R 7 / R 7 a \vert < 2.1 ; and \vert R 6 a - R 7 \vert < 5.$$

In the embodiments, the fourth lens group 340 includes the fifth lens G5, the sixth lens G6, and the seventh lens G7. The object-side surface of the fifth lens G5 has a radius of curvature R5=−33.80 mm, and the image-side surface of the fifth lens G5 has a radius of curvature R5a=−100.72 mm. The image-side surface of the sixth lens G6 has a radius of curvature R6a=60.12 mm. The object-side surface of the seventh lens G7 has a radius of curvature R7=60.12 mm, and the image-side surface of the seventh lens G7 has a radius of curvature R7a=−31.97 mm. Based on actual parameter calculation, |R5/R5a|=|−33.80/(−100.72) |=0.34, which falls within the required range of 0.25 to 0.40; |R7/R7a|=|60.12/(−31.97) |=1.88, which falls within the required range of 1.7 to 2.1; and |R6a-R7|=|60.12−60.12|=0, which satisfies the condition of being less than 5.

The condition 0.25<|R5/R5a|<0.40 defines the fifth lens G5 as a positive-power biconcave lens. The actual value |R5/R5a=0.34 lies near the center of the range, indicating that the concave object-side surface of the fifth lens G5 is significantly stronger than the concave image-side surface of the fifth lens. This asymmetric biconcave configuration provides aberration-correcting capability to the optical system. The stronger concave object-side surface of the fifth lens (R5=−33.80 mm) efficiently receives the converging beam from the third lens group 330, while the weaker concave image-side surface of the fifth lens (R5a=−100.72 mm) provides gradual beam adjustment, thereby ensuring a smooth transition of the beam to the sixth lens G6.

When the ratio is controlled within the range of 0.25 to 0.40, the fifth lens G5 provides the necessary positive optical power while effectively controlling spherical aberration and coma. If the ratio falls below 0.25, the curvature difference between the concave object-side surface and the concave image-side surface is too small to offer sufficient aberration correction capability. If the ratio exceeds 0.40, the concave object-side surface becomes overly strong, resulting in excessive beam deflection and the generation of higher-order aberrations. The actual value of 0.34 ensures that the fifth lens G5 achieves optimal aberration correction within a complex multi-lens system.

The condition 1.7<|R7/R7a|<2.1 is critical to the optical performance of the seventh lens G7. The seventh lens G7 has a biconvex shape and is configured to converge light and perform final aberration correction for the fourth lens group 340. The actual value |R7/R7a|=1.88 lies near the center of the range, indicating that the convex object-side surface of the seventh lens G7 has a moderate curvature, and the convex image-side surface of the seventh lens G7 is relatively stronger. Thus, the seventh lens G7 provides the necessary convergence while achieving precise aberration correction through its stronger convex image-side surface.

The ratio of radii of curvature is controlled within the range of 1.7 to 2.1, ensuring that the seventh lens G7 achieves favorable optical cooperation with the preceding fifth lens G5 and sixth lens G6. If the ratio falls below 1.7, the convex image-side surface of the seventh lens G7 becomes relatively too strong, causing excessive beam convergence and degrading aberration performance. If the ratio exceeds 2.1, the convex image-side surface of the seventh lens G7 becomes too weak, failing to provide sufficient aberration correction capability. The actual value of 1.88 reflects a precise balance between beam convergence capability and aberration control.

The condition |R6a−R7|<5 defines the optical matching between the sixth lens G6 and the seventh lens G7. The actual parameters show that R6a=60.12 mm and R7=60.12 mm, which are exactly equal, namely |R6a−R7|=0. This exact matching of radii of curvature ensures a smooth transition of the beam from the image-side surface of the sixth lens G6 to the object-side surface of the seventh lens G7, reducing beam deflection and interface reflection losses.

In conjunction with the preceding optical simulation analysis, the fourth lens group 340 fully demonstrates its important role in the entire system. The excellent image plane flatness (sagittal field curvature <0.01 mm) shown in the field curvature diagram, and the favorable light convergence characteristics exhibited in the ray fan diagram, are both highly related to the configuration of the fourth lens group 340.

Through the control of the three conditional expressions and the cooperative interaction of the three lenses, the fourth lens group 340 successfully achieves effective correction of residual aberrations from the preceding lens groups. This ensures that the outstanding optical performance of the camera lens is fully transmitted to the mobile phone sensor, thereby providing a solid technical foundation for the seamless integration of professional photography and mobile photography.

Further, in the embodiments, a paraxial distance from the image-side surface of the fourth lens G4 to the object-side surface of the fifth lens G5 is recorded as T3, and a paraxial distance from the image-side surface of the fifth lens G5 to the object-side surface of the sixth lens G6 is recorded as T4. The following relationships are satisfied:

$$5.5 < T 3 / T 4 < 6.5 ;$$

$$0.05 < T 3 / L < 0 \text{.08} ;$$

$$0.008 < T 4 / L < 0.015 ; and$$

$$0.55 < T 3 / f < 0.75 .$$

In the embodiments, the condition 5.5<T3/T4<6.5 defines the spatial allocation strategy among different functional regions within the fourth lens group 340. The actual ratio T3/T4=6.06 indicates that the distance between the fourth lens G4 and the fifth lens G5 is approximately six times the distance between the fifth lens G5 and the sixth lens G6. This spatial difference reflects the different space requirements of the respective optical transition processes. The larger distance T3 provides sufficient space for the beam to transition from the third lens group 330 to the fourth lens group 340, allowing the beam to attain an appropriate divergence state before entering the fourth lens group 340. The smaller distance T4 ensures close optical coupling among the lenses within the fourth lens group 340, enabling effective optical coupling between the fifth lens G5 and the sixth lens G6.

The condition 0.55<T3/f<0.75 establishes a direct proportional relationship between the entrance spacing of the fourth lens group 340 and the focal length of the system. The actual value T3/f=0.65 indicates that the entrance spacing of the fourth lens group 340 is approximately 65% of the system focal length, ensuring coordination between spatial configuration and optical performance. When the ratio is controlled within the range of 0.55 to 0.75, sufficient space is provided for beam transition while preserving system compactness.

The cooperative constraints of the conditions 0.05<T3/L<0.08 and 0.008<T4/L<0.015 ensure that the axial distances of the fourth lens group 340 occupy a reasonable proportion of the total system length. This hierarchical spatial control strategy not only optimizes optical performance but also provides ideal geometric conditions for the cooperative configuration of the three lenses within the fourth lens group 340. The relatively larger proportion of T3 relative to the total length ensures sufficient space for beam state transition, while the smaller proportion of T4 guarantees close optical coupling within the lens group.

The condition T3/T4 controls the spatial allocation within the lens group from a local functional perspective. The condition T3/f establishes the relationship between spatial arrangement and optical performance from the overall system perspective. The conditions T3/L and T4/L control spatial utilization efficiency from the perspective of structural compactness.

This multi-level spatial control strategy enables the fourth lens group 340 to achieve optimal optical performance within a limited space. By precisely controlling the axial distances, the three lenses of the fourth lens group 340 can each realize their best optical function in their respective zones, while preserving the overall structural compactness and manufacturing feasibility of the system.

Refer to Table 1.

TABLE 1

| | | | | | Abbe |
|---|---|---|---|---|---|
| | | Radius of | Thickness | Refractive | number |
| Surface | | curvature R | D | index Nd | Vd |
| 1 | First lens | Infinite | 10.850 | 1.84666 | 1.84666 |
| 2 | Second lens | −16.016 | 1.500 | 1.6779 | 1.6779 |
| 3 | | 48.061 | 3.790 | | |
| 4 | Third lens | −31.324 | 6.970 | 1.84666 | 23.784497 |
| 5 | Fourth lens | −22.697 | 1.500 | 1.5168 | 64.198732 |
| 6 | | 95.041 | 7.000 | | |
| 7 | Fifth lens | −51.425 | 8.700 | 1.804 | 46.574487 |
| 8 | | −22.594 | 0.200 | | |
| 9 | Sixth lens | Infinite | 5.660 | 1.804 | 46.574487 |
| 10 | | −54.478 | 8.360 | | |
| 11 | Seventh lens | −33.808 | 2.000 | 1.64769 | 33.840317 |
| 12 | | 100.720 | 1.380 | | |
| 13 | Eighth lens | Infinite | 2 | 1.80518 | 25.456256 |
| 14 | Nineth lens | 60.122 | 9.62 | 1.7725 | 49.598996 |
| 15 | | −31.976 | 0.2 | | |
| 16 | Tenth lens | 30.280 | 5.03 | 1.7725 | 49.598996 |
| 17 | | 84.850 | 0.2 | | |
| 18 | Eleventh | 15.010 | 7.49 | 1.7725 | 49.598996 |
| | lens | | | | |
| 19 | | 12.060 | | | |

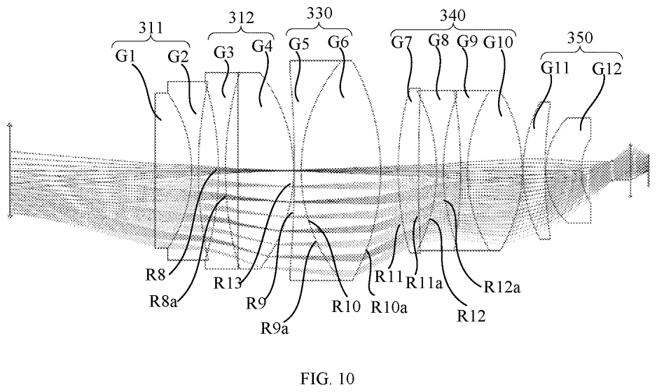

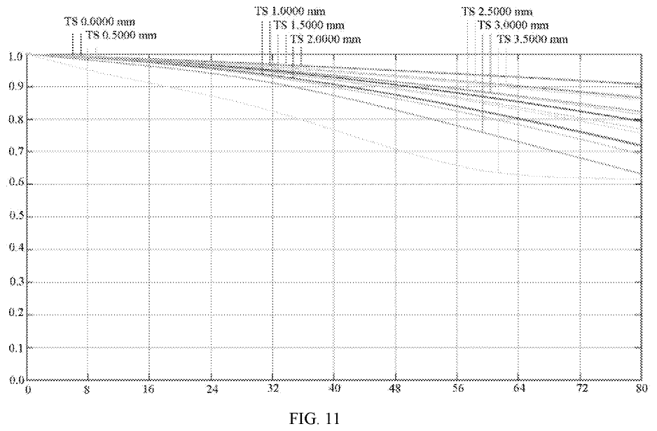

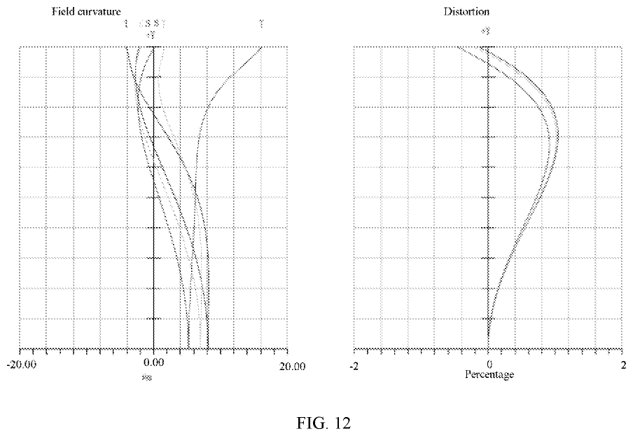

In some embodiments, referring to FIG. 10 to FIG. 12, the present disclosure further provides a lens adapter device, including a first lens group 311, a second lens group 312, a third lens group 330, a fourth lens group 340, and a fifth lens group 350 arranged along the optical axis X from the object side OD to the image side IM of the lens adapter device.

The first lens group 311 includes a first lens G1 and a second lens G2. Each of the first lens G1 and the second lens G2 has a negative optical power. An image-side surface of the first lens G1 is convex in the paraxial region. An object-side surface and an image-side surface of the second lens G2 are concave in the paraxial region.

The second lens group 312 includes a third lens G3 and a fourth lens G4. Each of the third lens G3 and the fourth lens G4 has a negative optical power. An object-side surface and an image-side surface of the third lens G3 are both concave in the paraxial region. An image-side surface of the fourth lens G4 is convex in the paraxial region.

The third lens group 330 includes a fifth lens G5 and a sixth lens G6. Each of the fifth lens G5 and the sixth lens G6 has a negative optical power. An object-side surface and an image-side surface of the fifth lens G5 are both concave in the paraxial region. An object-side surface and an image-side surface of the sixth lens G6 are both spherical in the paraxial region.

The fourth lens group 340 includes a seventh lens G7, an eighth lens G8, a ninth lens G9, and a tenth lens G10. Each of the seventh lens G7, the eighth lens G8, the ninth lens G9, and the tenth lens G10 has a positive optical power. An object-side surface of seventh lens G7 is convex in the paraxial region. An object-side surface and an image-side surface of the eighth lens G8 are both concave in the paraxial region. An object-side surface and an image-side surface of the ninth lens G9 are both concave in the paraxial region. An object-side surface and an image-side surface of the tenth lens G9 are both convex in the paraxial region.

The fifth lens group 350 includes an eleventh lens G11 and a twelfth lens G12. Each of the eleventh lens G11 and the twelfth lens G12 has a positive optical power. An object-side surface of the eleventh lens G11 is convex in the paraxial region. An object-side surface of the twelfth lens G12 is spherical in the paraxial region, and an image-side surface of the twelfth lens G12 is concave in the paraxial region. An effective focal length of the lens adapter device is recorded as f10, an effective focal length of the first lens group 311 is recorded as f11, an effective focal length of the second lens group 312 is recorded as f12, an effective focal length of the third lens group 330 is recorded as f13, and an effective focal length of the fourth lens group 340 is recorded as f14. The following relationships are satisfied:

$$140 < f 11 / f 10 < 150 ;$$

$$7.5 < f 12 / f 10 < 8.5 ;$$

$$4.2 < f 13 / f 10 < 4.8 ; and$$

$$270 < f 14 / f 10 < 290 .$$

In the embodiments, the effective focal length f10 of the lens adapter device is 12.0 mm, the effective focal length f11 of the first lens group 311 is 1716.57 mm, the effective focal length f12 of the second lens group 312 is 92.91 mm, the effective focal length f13 of the third lens group 330 is 53.09 mm, the effective focal length f14 of the fourth lens group 340 is 3324.43 mm, and the effective focal length f15 of the fifth lens group 350 is 46.16 mm.

The configuration of the focal length ratio f11/f10=143.05 for the first lens group 311 embodies the control of the ultra-long focal length negative-power component. This extremely high focal length ratio (approximately 143 times the system focal length) ensures that the first lens group 311 has a very weak negative optical power, its primary function being to gently receive the exited beam from the camera lens while avoiding the introduction of excessive primary aberrations. If the ratio falls below 140, the negative optical power of the first lens group 311 is relatively too strong, causing excessive beam divergence and affecting the operational efficiency of subsequent lens groups. If the ratio exceeds 150, the optical power of the first lens group 311 is too weak to provide necessary beam control, potentially leading to a decline in overall system performance. The actual value of 143.06 lies at an ideal position within the range, ensuring optimal optical performance at the system entrance end.

The focal length ratio of the second lens group 312, f12/f10=7.74, reflects a moderately strong negative optical power. The second lens group is configured for preliminary beam divergence and pre-correction of aberrations, with a focal power approximately 1/7.74 of the system power. This moderate negative power configuration effectively expands the beam angle to create conditions for subsequent image size reduction, while avoiding excessive divergence that would lead to light loss. When the ratio is maintained within the range of 7.5 to 8.5, the second lens group 312 achieves an optimal balance between beam divergence and aberration control.

The focal length ratio of the third lens group 330, f13/f10=4.42, indicates a relatively strong negative optical power, approximately 1/4.42 of the system power. As the final group in the negative-power subsystem, the third lens group 330 needs to complete the final beam divergence adjustment in preparation for the transition to the positive-power fourth lens group 340. When the ratio is controlled within the range of 4.2 to 4.8, sufficient beam divergence is ensured while avoiding the adverse effects of excessive divergence on system stability.

The fourth lens group 340 is configured for fine control and aberration correction of the beam generated by the preceding three lens groups. When the ratio is maintained within the range of 270 to 290, the fourth lens group 340 can perform precise beam control without introducing significant aberrations.

In the embodiments, the first three lens groups, each having the negative optical power, achieve gradual beam divergence. Their focal length ratios exhibit a decreasing trend (143.05→7.74→4.42), reflecting progressively increasing focal power. This ensures a smooth transition of the beam from the receiving state to the divergent state, avoiding abrupt optical changes. The fourth lens group and the fifth lens group have the positive optical power and are configured to re-converge the beam and form the final image. The ultra-long focal length configuration of the fourth lens group 340 enables precise beam control, while the moderate focal length of the fifth lens group 350 performs the final imaging function.

In some embodiments, a paraxial radius of curvature of the object-side surface of the third lens G3 is recorded as R8, a paraxial radius of curvature of the image-side surface of the third lens G3 is recorded as R8a, and a paraxial radius of curvature of the image-side surface of the fourth lens G4 is recorded as R13. The following relationships are satisfied:

$$0.8 < \vert R 8 / R 8 a \vert < 1. ;$$

$$1.8 < \vert R 8 a / R 13 \vert < 2.3 ; and$$

$$45 < \vert R8 \vert < 85 .$$

In the embodiments, R8=65.68 mm, R8a=74.88 mm, R13=−34.83 mm.

|R8/R8a|=|65.68/74.88|=0.88, which falls within the required range of 0.8 to 1.0.

|R8a/R13|=|74.88/(−34.83) |=2.15, which falls within the required range of 1.8 to 2.3.

|R8|=|65.68|=65.68, which falls within the required range of 45 to 85.

The condition 0.8<|R8/R8a|<1.0 controls the curvature ratio between the two optical surfaces of the third lens G3. The actual value of 0.88 ensures a moderate surface shape difference, which is favorable for aberration correction. The condition 1.8<|R8a/R13|<2.3 establishes a curvature matching relationship between the third lens G3 and the fourth lens G4. The actual value of 2.15 ensures good optical transition. The condition 45<|R8|<85 defines the curvature range of the object-side surface. The actual value of 65.68 mm provides appropriate beam control capability.

In some embodiments, the fifth lens G5 has a negative optical power. A paraxial radius of curvature of the object-side surface of the fifth lens G5 is recorded as R9, and a paraxial radius of curvature of the image-side surface of the fifth lens G5 is recorded as R9a. The sixth lens G6 has a positive optical power. A paraxial radius of curvature of the object-side surface of the sixth lens G6 is recorded as R10, and a paraxial radius of curvature of the image-side surface of the sixth lens G6 is recorded as R10a. The following relationships are satisfied:

$$6. < \vert R9 / R9a \vert < 7. ;$$

$$0.7 < \vert R 10 / R 10 a \vert < 0.9 ; and$$

$$\vert R 9 a - R 10 \vert < 1. .$$

In the embodiments, the condition 6.0<|R9/R9a|<7.0 controls the curvature ratio of the fifth lens G5. The actual value of 6.57 ensures a moderate surface shape difference for this negative-power lens, which is beneficial for beam divergence and aberration correction. The condition 0.7<|R10/R10a|<0.9 defines the curvature configuration of the sixth lens G6, and the actual value of 0.755 ensures favorable optical performance for this positive-power lens.

The condition |R9a−R10|<1.0 defines the degree of matching between the fifth lens G5 and the sixth lens G6. The actual parameters show that R9a and R10 are exactly equal (37.221 mm), ensuring a smooth beam transition between the two lenses, reducing interface reflection losses, and reflecting a high-precision optical design. The condition 25<|R9|+R10a|<35 controls the overall curvature distribution of the system.

In some embodiments, an axial distance from the image-side surface of the sixth lens G6 to the object-side surface of the seventh lens G7 is recorded as T5. The following relationships are satisfied:

$$0.025 < T 5 / L < 0.035 ;$$

$$0.25 < T 5 / f < 0 \text{.35} ;$$

$$1.8 < T 1 / T 5 < 2.2 ; and$$

$$3. < T 5 < 4.5 .$$

In some embodiments, T5=3.850 mm.

The condition 3.0<T5<4.5 directly limits the axial distance between the sixth lens G6 and the seventh lens G7. The actual value T5=3.850 mm lies in the medium-to-high portion of the range, ensuring appropriate optical space between the two lenses for beam control. This distance provides sufficient room for the beam to transition from the third lens group 330 to the fourth lens group 340.

The condition 0.025<T5/L<0.035 defines the ratio of the axial distance T5 to the total system length. This relatively small proportion ensures a compact system design while providing the necessary space for the critical optical transition region. This ratio range reflects precise control over spatial utilization.

The condition 0.25<T5/f<0.35 establishes a direct relationship between the axial distance and the system focal length, reflecting coordination between spatial configuration and optical performance. This ratio ensures that the axial distance T5 is appropriately scaled to the system's optical requirements, maintaining optimal optical performance.

The condition 1.8<T1/T5<2.2 defines the ratio between different lens group spaces, reflecting a spatial allocation strategy among distinct functional regions of the optical system. By controlling the T1/T5 ratio within the specified range, it is ensured that each optical region receives adequate working space.

Referring to FIG. 10, in the embodiments, a paraxial radius of curvature of the object-side surface of the seventh lens G7 is recorded as R11, and a paraxial radius of curvature of the image-side surface of the seventh lens G7 is recorded as R11a, a paraxial radius of curvature of the object-side surface of the eighth lens G8 is recorded as R12, and a paraxial radius of curvature of the image-side surface of the eighth lens G8 is recorded as R12a. The following conditions are satisfied:

$$0.15 < \vert R 11 / R 11 a \vert < 0.2 ; and 0.75 < \vert R 12 / R 12 a \vert < 0. 95 .$$

In some embodiments, R11=64.913 mm, R11a=388.654 mm, R12=−37.944 mm, R12a=46.342 mm.

From actual parameter calculations:

|R11/R11a|=|64.913/388.654|=0.167, satisfying the range requirement of 0.15 to 0.20.

|R12/R12a|=|−37.944/46.342|=0.819, satisfying the range requirement of 0.75 to 0.95.

The condition 0.15<|R11/R11a|<0.20 defines the curvature ratio configuration of the seventh lens G7. The actual value of 0.167 indicates that the object-side surface of the seventh lens G7 has a relatively strong curvature, while the image-side surface of the seventh lens G7 is relatively gentle. This ensures that the seventh lens G7 performs an effective beam control function within the fourth lens group 340. The relatively strong curvature on the object side facilitates reception of the beam from the third lens group 330, while the gentle curvature on the image side promotes smooth beam transmission.

The condition 0.75<|R12/R12a|<0.95 defines the curvature configuration of the eighth lens G8. The actual value of 0.819 lies near the middle of the range, indicating that the two surfaces of the eighth lens G8 have a relatively balanced curvature distribution. This design enables the eighth lens G8 to perform an important aberration correction function within the fourth lens group 340, achieving effective control of aberrations such as spherical aberration and coma through a moderate curvature ratio.

The curvature radius configurations of the seventh lens G7 and the eighth lens G8 reflect the precise optical design within the fourth lens group 340. The seventh lens G7 achieves preliminary beam control through a curvature ratio of 0.167, while the eighth lens G8 performs fine aberration correction through a curvature ratio of 0.819. The synergistic interaction of the two lenses ensures that the fourth lens group 340 can achieves optimal performance in both beam convergence and aberration control, thereby providing an important guarantee for the excellent overall performance of the entire lens adapter device.

Refer to Table 2.

TABLE 2

| | | | | | Abbe |
|---|---|---|---|---|---|
| | | Radius of | Thickness | Refractive | number |
| Surface | | curvature R | D | index Nd | Vd |
| 1 | First lens | Infinite | 7.960 | 1.84666 | 23.784497 |
| 2 | Second lens | −30.203 | 1.500 | 1.62041 | 60.339343 |
| 3 | | 89 158 | 4.420 | | |
| 4 | Third lens | −65.688 | 1.500 | 1.62041 | 60 339343 |
| 5 | | 74.880 | 2.730 | | |
| 6 | Fourth lens | Infinite | 12 219 | 1.84666 | 23 784497 |
| 7 | | −34.839 | 0.200 | | |
| 8 | Fifth lens | 244.400 | 1.500 | 1.6727 | 32 171186 |
| 9 | Sixth lens | 37.221 | 17.440 | 1.84666 | 23.784497 |
| 10 | | −49.311 | 3.850 | | |
| 11 | Seventh lens | 64.913 | 4.460 | 1.804 | 46.574487 |
| 12 | | 388.654 | 3.950 | | |
| 13 | Eighth lens | −37.944 | 1.5 | 1.84666 | 23.784497 |
| 14 | | 46.342 | 3.81 | | |
| 15 | Nineth lens | −105.707 | 1.5 | 1.6727 | 32 171186 |
| 16 | Tenth lens | 33 820 | 12 | 1.804 | 46.574487 |
| 17 | | −33.820 | 0.2 | | |
| 18 | Eleventh | 31.95 | 4.79 | 1.804 | 46.574487 |
| | lens | | | | |
| 19 | | 91.759 | 0.2 | | |
| 20 | Twelfth lens | 16.396 | 7.75 | 1.804 | 46.574487 |
| 21 | | 12.987 | 6.81 | | |

The present disclosure further provides a mobile phone protective case 100, including the lens adapter device 300 according to any of the foregoing embodiments. The specific structure of the lens adapter device 300 is as described in the foregoing embodiments. Since the mobile phone protective case 100 adopts all the technical solutions of all the foregoing embodiments, it possesses at least all the technical effects brought about by the technical solutions of the foregoing embodiments, which is not detailed herein. The mobile phone protective case 100 further includes a first mounting portion 101 and a second mounting portion 102. The first mounting portion 101 is configured to receive a mobile phone F. The second mounting portion 102 is connected to the second end 301b of the lens barrel 301 by threads or a snap-fit connection.

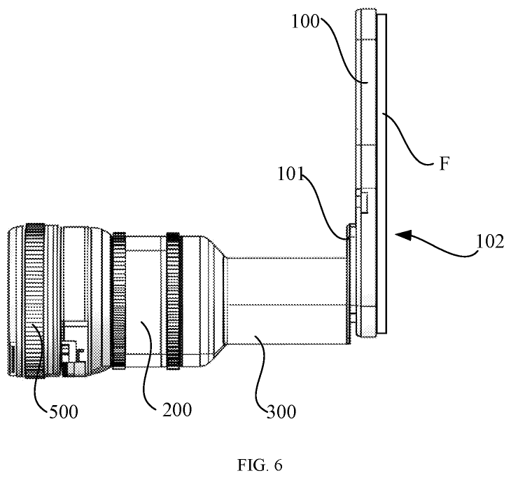

Referring to FIG. 6, in the embodiments, the mobile phone protective case 100 includes the first mounting portion 101 and the second mounting portion 102. The first mounting portion 101 is configured as a housing that fits over the mobile phone F, capable of securely accommodating and protecting the mobile phone while allowing normal operation and use of the mobile phone F. The second mounting portion 102 is configured for connection with the second end 301b of the lens barrel 301, enabling a fast and secure connection via a threaded or snap-fit arrangement.

Thus, the user can easily connect and use the camera lens 500 while keeping protecting the mobile phone F. When performing professional photography, the user simply needs to connect the camera lens 500 to the first end 301a of the lens barrel 301 via the lens adapter ring 200, and then connect the second end 301b of the lens barrel 301 to the second mounting portion 102 of the mobile phone protective case 100. This is easy to assemble, intuitive to operate, and requires no complex adjustment process.

Since the mobile phone protective case 100 adopts all the technical solutions of all the foregoing embodiments, it inherits all the technical advantages and effects of the aforementioned lens adapter device 300, including perfect optical matching between the camera lens and the mobile phone camera, high-quality imaging performance, and effective control of various aberrations. This enables a mobile phone equipped with the protective case to achieve photographic effects approaching the level of a professional camera, greatly expanding the application scenarios and creative possibilities of mobile phone photography.

The present disclosure further provides a mobile phone high-definition photography system, including a mobile phone F, a camera lens 500, and the mobile phone protective case 100 according to any of the foregoing embodiments.

Referring to FIG. 6, in the embodiments, the mobile phone high-definition photography system includes the mobile phone F, the camera lens 500, and the mobile phone protective case 100 (which is integrated with the lens adapter device 300) as described in detail in the foregoing embodiments. The three cooperate with one another to form the high-quality photography system.

The mobile phone acts as the core computing and display platform, providing functions such as image processing, storage, preview, and sharing. The system is compatible with mainstream phone models, thereby meeting the needs of most users.

The camera lens 500 leverages existing professional photography resources. The system supports a wide range of lens brands and specifications, including but not limited to common wide-angle, standard, telephoto, and macro lenses. This open and compatible design allows users to flexibly select the most suitable lens for different shooting scenarios, greatly enhancing the expressive power and creative possibilities of mobile phone photography.

The mobile phone protective case 100, which is provided with the lens adapter device 300, serves as a bridge connecting the mobile phone and the camera lens 500. Through a precisely designed optical system, it solves the optical matching problem between the two, ensuring high imaging quality and stability.

To use the system, the user simply fits the mobile phone into the protective case and connects the camera lens 500 via the lens adapter device; the system is then ready for shooting. The overall system is compact and lightweight for easy portability, and is simple and intuitive to operate.

Through this highly integrated design, professional-grade photography is brought to mobile devices, offering users an experience close to that of a dedicated camera.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A lens adapter device for a mobile phone high-definition photography system, the mobile phone high-definition photography system comprising a mobile phone protective case for mounting a mobile phone, and the lens adapter device comprising:
a lens barrel having a first end and a second end opposite each other, the first end being configured to detachably connect to a camera lens, and the second end being configured to detachably connect to the mobile phone protective case;
a first lens unit disposed within the lens barrel, an object-side surface of the first lens unit being planar, and an image-side surface of the first lens unit being convex; and
a second lens unit disposed within the lens barrel and spaced apart from the first lens unit, an object-side surface of the second lens unit being planar, and an image-side surface of the second lens unit being concave.

2. The lens adapter device of claim 1, wherein,
the first lens unit and the second lens unit are arranged along an optical axis of the lens adapter device and spaced apart from each other;
the first lens unit comprises:
a first lens group having a positive optical power, an object-side surface of the first lens group being planar, and an image-side surface of the first lens group being convex; and
a second lens group disposed on a side of first lens group facing the image-side surface of first lens group and spaced apart from the first lens group, the second lens group having a negative optical power, an object-side surface of the second lens group being concave, and an image-side surface of the second lens group being convex; and
the second lens unit comprises:
a third lens group having a positive optical power, an object-side surface of the third lens group being planar, and an image-side surface of the third lens group being convex;
a fourth lens group having a positive optical power, an object-side surface of the fourth lens group being convex, and an image-side surface of the fourth lens group being planar; and
a fifth lens group having a negative optical power, an object-side surface of the fifth lens group being convex, and an image-side surface of the fifth lens group being concave.

3. The lens adapter device of claim 1, wherein,
the first lens unit comprises two lens groups, and the second lens unit comprises three lens groups; wherein,
a total number of lenses in the first lens unit and the second lens unit is five; or,
a total number of lenses in the first lens unit and the second lens unit is eleven.

4. The lens adapter device of claim 2, wherein the first lens group comprises a first lens, a second lens, a third lens, and a fourth lens arranged sequentially from an object side to an image side of the lens adapter device; wherein,
an object-side surface of the first lens is planar, and an image-side surface of the first lens is convex and configured with a first radius of curvature;
an object-side surface of the second lens is concave and configured with a second radius of curvature, and an image-side surface of the second lens is convex and configured with a third radius of curvature;
an object-side surface of the third lens is concave and configured with a fourth radius of curvature, and an image-side surface of the third lens is planar;
an object-side surface of the fourth lens is concave and configured with a fifth radius of curvature, and an image-side surface of the fourth lens is convex and configured with a sixth radius of curvature;
wherein the first radius of curvature is smaller than the second radius of curvature, the second radius of curvature is smaller than the third radius of curvature, the third radius of curvature is smaller than the fourth radius of curvature, the fourth radius of curvature is smaller than the fifth radius of curvature, and the fifth radius of curvature is smaller than the sixth radius of curvature;
the first lens, the second lens, the third lens, and the fourth lens are arranged in contact with one another; and
an effective optical diameter of the first lens is smaller than an effective optical diameter of the second lens, the effective optical diameter of the second lens is smaller than an effective optical diameter of the third lens, and the effective optical diameter of the third lens is smaller than an effective optical diameter of the fourth lens.

5. The lens adapter device of claim 4, wherein the second lens group comprises a fifth lens spaced apart from the fourth lens; wherein,
an object-side surface of the fifth lens is concave and configured with a seventh radius of curvature, and an image-side surface of the fifth lens is convex and configured with an eighth radius of curvature, wherein the seventh radius of curvature is smaller than the eighth radius of curvature; and
an effective optical diameter of the fifth lens is greater than the effective optical diameter of the fourth lens.

6. The lens adapter device of claim 5, wherein the third lens group comprises a sixth lens, a seventh lens, and an eighth lens arranged sequentially from the object side to the image side; wherein,
an object-side surface of the sixth lens is planar, and an image-side surface of the sixth lens is concave and configured with a ninth radius of curvature;
an object-side surface of the seventh lens is planar, an image-side surface of the seventh lens is concave and configured with a tenth radius of curvature, and an effective optical diameter of the seventh lens is equal to an effective optical diameter of the sixth lens;
an object-side surface of the eighth lens is convex and configured with an eleventh radius of curvature, an image-side surface of the eighth lens is convex configured with a twelfth radius of curvature, and an effective optical diameter of the eighth lens is equal to the effective optical diameter of the seventh lens; and
the object-side surface of the sixth lens is spaced apart from the image-side surface of the fifth lens; and
the sixth lens, the seventh lens, and the eighth lens are arranged in contact.

7. The lens adapter device of claim 6, wherein the fourth lens group comprises a ninth lens; wherein,
an object-side surface of the ninth lens is convex and configured with a thirteen radius of curvature, and an image-side surface of the ninth lens is planar;
the object-side surface of the ninth lens is in contact with the image-side surface of the eighth lens; and
an effective optical diameter of the ninth lens is smaller than the effective optical diameter of the eighth lens.

8. The lens adapter device of claim 2, wherein the fifth lens group is a cemented lens; wherein,
an object-side surface of the cemented lens is convex, and an image-side surface of the cemented lens is concave;
the cemented lens is configured to focus a light beam onto a same plane; and
an effective optical diameter of the fifth lens group is smaller than the effective optical diameter of the fourth lens group.

9. A lens adapter device, comprising a lens barrel and a lens group disposed within the lens barrel, the lens group comprising a first lens group, a second lens group, a third lens group, a fourth lens group, and a fifth lens group sequentially arranged along an optical axis from an object side to an image side of the lens barrel; wherein,
the first lens group has a negative optical power, and an image-side surface of the first lens group is concave;
the second lens group has a negative optical power, an object-side surface and an image-side surface of the second lens group are both concave;
the third lens group has a positive optical power, an object-side surface of the third lens group is concave, and an image-side surface of the third lens group is convex;
the fourth lens group has a negative optical power, an object-side surface of the fourth lens group is concave, and an image-side surface of the fourth lens group is spherical; and
the fifth lens group has a negative optical power, an object-side surface of the fifth lens group is convex, and an image-side surface of the fifth lens group is concave;
wherein a focal length of the lens adapter device is recorded as f, an effective focal length of the second lens group is recorded as f2, an effective focal length of the third lens group is recorded as f3, and an effective focal length of the fourth lens group is recorded as f4;
the following relationships are satisfied:
$$0 \text{.1} < \vert f / f 2 \vert < 0.3 ;$$
$$0.4 < \vert f / f 3 \vert < 0.6 ; and$$
$$0.03 < \vert f / f 4 \vert < 0. 06 .$$

10. The lens adapter device of claim 9, wherein the second lens group comprises a first lens and a second lens arranged along the optical axis from the object side to the image side; wherein,
the first lens has a negative optical power; and
the second lens has a negative optical power;
wherein a paraxial radius of curvature of an object-side surface of the first lens is recorded as R1, a paraxial radius of curvature of an image-side surface of the first lens is recorded as R1a, a paraxial radius of curvature of an object-side surface of the second lens is recorded as R2, and a paraxial radius of curvature of an image-side surface of the second lens is recorded as R2a;
the following relationships are satisfied:
$$1 < \vert R 1 / R 1 a \vert < 1.4 ; and$$
$$0.2 < \vert R 2 / R 2 a \vert < 0. 4 .$$

11. The lens adapter device of claim 10, wherein the third lens group comprises a third lens and a fourth lens arranged along the optical axis from the object side to the image side; wherein,
the third lens has a positive optical power, an object-side surface of the third lens is concave, and an image-side surface of the third lens is convex; and
the fourth lens has a positive optical power, an object-side surface of the fourth lens is planar, and an image-side surface of the fourth lens is convex;
wherein a paraxial radius of curvature of the object-side surface of the third lens is recorded as R3, a paraxial radius of curvature of the image-side surface of the third lens is recorded as R3a, and a paraxial radius of curvature of the image-side surface of the fourth lens is recorded as R4a;
the following relationships are satisfied:
$$2. < \vert R 3 / R 3 a \vert < 2.6 ; and$$
$$45 < \vert R 4 a \vert < 65 .$$

12. The lens adapter device of claim 11, wherein a length of the lens adapter device along the optical axis is recorded as L, an axial distance from the image-side surface of the second lens to the object-side surface of the third lens is recorded as T1, and an axial distance from the image-side surface of the third lens to the object-side surface of the fourth lens is recorded as T2;
the following relationships are satisfied:
$$0.04 < T 1 / L < 0.08 ; and$$
$$30 < T 1 / T 2 < 40 .$$

13. The lens adapter device of claim 11, wherein the fourth lens group comprises a fifth lens, a sixth lens, and a seventh lens sequentially arranged along the optical axis from the object side to the image side; wherein,
the fifth lens has a positive optical power, an object-side surface and an image-side surface of the fifth lens are both concave;
the sixth lens has a negative optical power, and an image-side surface of the sixth lens is concave; and
the seventh lens has a positive optical power, an object-side surface and an image-side surface of the seventh lens are both convex;
wherein a paraxial radius of curvature of the object-side surface of the fifth lens is recorded as R5, a paraxial radius of curvature of the image-side surface of the fifth lens is recorded as R5a, a paraxial radius of curvature of the image-side surface of the sixth lens is recorded as R6a, a paraxial radius of curvature of the object-side surface of the seventh lens is recorded as R7, and a paraxial radius of curvature of the image-side surface of the seventh lens is recorded as R7a;
the following relationships are satisfied:
$$0.25 < \vert R 5 / R 5 a \vert < 0.4 ;$$
$$1.7 < \vert R 7 / R 7 a \vert < 2.1 ; and$$
$$\vert R 6 a - R 7 \vert < 5.$$

14. The lens adapter device of claim 13, wherein a length of the lens adapter device along the optical axis is recorded as L, a paraxial distance from the image-side surface of the fourth lens to the object-side surface of the fifth lens is recorded as T3, and a paraxial distance from the image-side surface of the fifth lens to the object-side surface of the sixth lens is recorded as T4;
the following relationships are satisfied:
$$5.5 < T 3 / T 4 < 6.5 ;$$
$$0.05 < T 3 / L < 0 \text{.08} ;$$
$$0.008 < T 4 / L < 0.015 ; and$$
$$0.55 < T 3 / f < 0.75 .$$

15. A lens adapter device, comprising a first lens group, a second lens group, a third lens group, a fourth lens group, and a fifth lens group sequentially arranged along an optical axis of the lens adapter device from an object side to an image side of the lens adapter device; wherein,
the first lens group comprises a first lens and a second lens; wherein each of the first lens and the second lens has a negative optical power; an image-side surface of the first lens is convex in a paraxial region; an object-side surface and an image-side surface of the second lens are both concave in the paraxial region;
the second lens group comprises a third lens and a fourth lens; wherein each of the third lens and the fourth lens has a negative optical power; an object-side surface and an image-side surface of the third lens are both concave in the paraxial region; an image-side surface of the fourth lens is convex in the paraxial region;
the third lens group comprises a fifth lens and a sixth lens; wherein each of the fifth lens and the sixth lens has a negative optical power; an object-side surface and an image-side surface of the fifth lens are both concave in the paraxial region; an object-side surface and an image-side surface of the sixth lens are both spherical in the paraxial region;
the fourth lens group comprises a seventh lens, an eighth lens, a ninth lens, and a tenth lens; wherein each of the seventh lens, the eighth lens, the ninth lens, and the tenth lens has a positive optical power; an object-side surface of the seventh lens is convex in the paraxial region; an object-side surface and an image-side surface of the eighth lens are both concave in the paraxial region; an object-side surface and an image-side surface of the ninth lens are both concave in the paraxial region; an object-side surface and an image-side surface of the tenth lens are both convex in the paraxial region; and
the fifth lens group comprises an eleventh lens and a twelfth lens; wherein each of the eleventh lens and the twelfth lens has a positive optical power; an object-side surface of the eleventh lens is convex in the paraxial region; an object-side surface of the twelfth lens is spherical in the paraxial region, and an image-side surface of the twelfth lens is concave in the paraxial region;
wherein an effective focal length of the lens adapter device is recorded as f10, an effective focal length of the first lens group is recorded as f11, an effective focal length of the second lens group is recorded as f12, an effective focal length of the third lens group is recorded as f13, and an effective focal length of the fourth lens group is recorded as f14;
the following relationships are satisfied:
$$140 < f 11 / f 10 < 150 ;$$
$$7.5 < f 12 / f 10 < 8.5 ;$$
$$4.2 < f 13 / f 10 < 4.8 ; and$$
$$270 < f 14 / f 10 < 290 .$$

16. The lens adapter device of claim 15, wherein a paraxial radius of curvature of the object-side surface of the third lens is recorded as R8, a paraxial radius of curvature of the image-side surface of the third lens is recorded as R8a, and a paraxial radius of curvature of the image-side surface of the fourth lens is recorded as R13;
the following relationships are satisfied:
$$0.8 < \vert R 8 / R 8 a \vert < 1. ;$$
$$1.8 < \vert R 8 a / R 13 \vert < 2.3 ;$$
$$\vert R 8 + R 8 a \vert < 15 ; and$$
$$45 < \vert R 8 \vert < 85 .$$

17. The lens adapter device of claim 15, wherein the fifth lens has a negative optical power, and the sixth lens has a positive optical power;
wherein a paraxial radius of curvature of the object-side surface of the fifth lens is recorded as R9, and a paraxial radius of curvature of the image-side surface of the fifth lens is recorded as R9a, a paraxial radius of curvature of the object-side surface of the sixth lens is recorded as R10, and a paraxial radius of curvature of the image-side surface of the sixth lens is recorded as R10a;
the following relationships are satisfied:
$$6. < \vert R 9 / R 9 a \vert < 7. ;$$
$$0.7 < \vert R 10 / R 10 a \vert < 0.9 ;$$
$$\vert R 9 a - R 10 \vert < 1. ; and$$
$$25 < \vert R9 \vert + \vert R10a \vert < 35 .$$

18. The lens adapter device of claim 17, wherein a length of the lens adapter device along the optical axis is recorded as L, a focal length of the lens adapter device is recorded as f, and a distance from the image-side surface of the sixth lens to the object-side surface of the seventh lens is recorded as T5;
the following relationships are satisfied:
$$0.025 < T 5 / L < 0.035 ;$$
$$0.25 < T 5 / f < 0 \text{.35} ;$$
$$1.8 < T 1 / T 5 < 2.2 ; and$$
$$3. < T 5 < 4.5 .$$

19. The lens adapter device of claim 15, wherein a paraxial radius of curvature of the object-side surface of the seventh lens is recorded as R11, a paraxial radius of curvature of the image-side surface of the seventh lens is recorded as R11a, a paraxial radius of curvature of the object-side surface of the eighth lens is recorded as R12, and a paraxial radius of curvature of the image-side surface of the eighth lens is recorded as R12a;
the following relationships are satisfied:
$$0.15 < \vert R 11 / R 11 a \vert < 0.2 ; and$$
$$0.75 < \vert R 12 / R 12 a \vert < 0. 95 .$$

20. A mobile phone protective case, comprising:
the lens adapter device of claim 1;
a first mounting portion configured to receive a mobile phone; and
a second mounting portion connected to the second end of the lens barrel by a threaded connection or a snap-fit connection.
